(19) United States
(12) Patent Application Publication
(10) Pub. No.: US 2018/0343891 A1
(43) Pub. Date: Dec. 6, 2018

(54) SYSTEM FOR AND A METHOD OF PRODUCING ENRICHED AND DIGESTED PROBIOTIC SUPER FEED USING WET MILL AND DRY MILL PROCESSES

(71) Applicant: Chie Ying Lee, San Jose, CA (US)

(72) Inventor: Chie Ying Lee, San Jose, CA (US)

(21) Appl. No.: 15/993,514

(22) Filed: May 30, 2018

Related U.S. Application Data
(60) Provisional application No. 62/513,815, filed on Jun. 1, 2017.

(51) Int. Cl. A23K 10/12; A23K 10/14; A23K 10/16; A23K 10/37; A23K 20/163; A23K 40/10; A23K 40/30; A23K 50/10; A23K 50/30; A23K 50/75; A23K 50/80

(52) U.S. Cl. CPC A23K 10/12; C12Y 302/01008; A23K 10/16; A23K 10/37; A23K 20/163; A23K 40/10; A23K 40/30; A23K 50/10; A23K 50/30; A23K 50/75; A23K 50/80; A23V 2002/00; A23V 2200/3204; A23V 2250/042; A23V 2300/31; C12Y 302/01001; C12Y 302/01004; A23K 10/14

(57) ABSTRACT

A method of and a system for digesting grain based protein and fiber materials using enzymes. The grain based protein and fiber materials can be found in whole stillage in an alcohol production. The method and system produces more digestible proteins, more soluble proteins, soluble protein fractions, peptides and amino acids for ruminant and monogastric species compared to the convention methods and systems. In some embodiments, digested fibers are used as absorber and protectant for probiotic culture absorbed in the enriched syrup. The digested fibers and the probiotic culture form a stable pellet. In some embodiments, the digested fibers and the probiotic culture is added to all types of animal feed forming an enriched lactic acid feed and live probiotic culture feed supplement for the feed markets. The feed markets includes aquaculture, poultry, swine, cattle, companion animals, and livestock animals.

### CROSS-REFERENCE TO RELATED APPLICATIONS

This application claims priority from U.S. Provisional Patent Application Ser. No. 62/513,815, filed Jun. 1, 2017 and entitled “A SYSTEM FOR AND A METHOD OF PRODUCING ENRICHED AND DIGESTED PROBIOTIC SUPER FEED USING WET MILL AND DRY MILL PROCESSES,” which is hereby incorporated herein by reference in its entirety for all purposes.

### FIELD OF THE INVENTION

The present invention relates to the field of animal feed. More specifically, the present invention relates to the systems and methods of producing nutrient enhanced animal feed.

### BACKGROUND

Some conventional alcohol production processes are illustrated in flow charts of FIGS. 1-5. FIG. 1 is a typical wet mill process for alcohol production. FIG. 2 is a typical dry grind alcohol process with a backend oil recovery system. FIG. 3 is a typical dry grind alcohol process with a backend oil and protein recovery system. FIG. 4 is a typical dry grind alcohol process with a secondary alcohol production. FIG. 5 is a typical dry grind alcohol process with an enriched syrup production system.

### SUMMARY OF INVENTION

FIGS. 1-5 provide the typical processes of alcohol production. Each and every step disclosed in the FIGS. 1-5 are incorporated by references can be optionally part of the embodiments of the present disclosure. Additional steps and processes are able to be added. The sequences of performing each of the steps are able to be in any order.

The conventional methods of producing various types of alcohols from grains generally follow similar wet or dry procedures. Wet mill corn processing plants convert corn grain into several different co-products, such as germ (for oil extraction), gluten feed (high fiber animal feed), gluten meal (high protein animal feed), and starch-based products such as high fructose corn syrup, or food and industrial starch as well as starch derived products such as ethanol. Dry grind ethanol plants convert corn into two products, namely ethanol and distiller's grains with solubles. If sold as wet animal feed, Distiller's Wet grains with Solubles is referred to as “DWGS.” If dried for animal feed, Distiller's Dried Grains with Solubles is referred to as “DDGS.” Distiller's Dried Grains is referred to as “DDG.” In the standard dry grind ethanol process, one bushel of corn yields approximately 8.2 kg (approximately 17 lbs.) of DDGS in addition to the approximately 10.3 liters (approximately 2.75 gal) of ethanol.

Distiller's based co-products provide a critical secondary revenue stream that offsets a portion of the overall ethanol production costs. DDGS is sold as a low value animal feed even though the DDGS contains 6 to 11% oil and 28 to 33% protein. Some plants have modified the typical dry mill process to separate the valuable oil and protein from DDGS. Currently, there are about 100 plants with the backend oil recovery system and use a process (as show in FIG. 2) that is disclosed in a patent (U.S. Pat. No. 7,601,858, which is incorporated by reference in its entirety for all purposes). Currently, there are about four plants with protein recovery system uses a process (as show in FIG. 3) that is disclosed in the patent application (PCT/US09/45163; filed on May 26, 2009; titled “METHODS FOR PRODUCING A HIGH PROTEIN CORN MEAL FROM A WHOLE STILLAGE BYPRODUCT AND SYSTEM THEREFORE,” which is incorporated by reference in its entirety for all purposes). Currently, there are about thirty plants that use a front-end grinding mill to increase alcohol yield, which uses a process disclosed in the patent (PCT/US12/30337; titled “DRY GRIND ETHANOL PRODUCTION PROCESS AND SYSTEM WITH FRONT END MILLING METHOD,” which is incorporated by reference in its entirety for all purposes) to increase an alcohol yield of the plant as well as to recover increased amounts of valuable oil from the syrup stream. There are also four plants for converting cellulose found in grain kernels to secondary alcohol used process (see FIG. 4). This cellulose to secondary alcohol process can be further improved by performing a backend grinding process as described in the patent application US 2014-005382929A-1, titled A METHOD OF AND SYSTEM FOR PRODUCE OIL AND VALABLE BYPRODUCT FROM GRAIN IN DRY MILLING SYSTEM WITH A BACK END DEWATER MILLING UNITED.

The soluble (syrup) fraction of the distiller's products is a under-valued commodity. The value and usage of the soluble should be improved in the alcohol production industry, which currently has about 200 dry grinding alcohol plants in operation in the U.S. alone.

A method of increasing the value of the above mentioned syrup is described in the U.S. patent application Ser. No. 15/187,702, titled “A METHOD OF AND SYSTEM FOR PRODUCING A HIGH VALUE ANIMAL FEED ADDITIVE FROM STILLAGE IN AN ALCOHOL PRODUCTION PROCESS.” The patent application discloses that the water soluble materials in whole stillage are used as a raw material for growth and propagation of different probiotic cultures. These cultures have valuable probiotic characters for making animal feeds as well as produce valuable for producing lactic acid in this enriched syrup. This process can produce more than 20% of lactic acid on a dry matter basis, and (generally around 10⁸ to 10¹⁰ CFU/g) probiotic units in a product of an enriched syrup.

In the above described alcohol producing process, a solid fraction (e.g., centrifuge solids or distillers wet grains (DWG)) is separated from the whole stillage. The solid fraction contains mainly fiber and protein in the composition. A liquid fraction (e.g., thin stillage or centrate or backset) is also separated from the whole stillage. The liquid fraction contains a higher concentrations of oil, soluble proteins and soluble ash from grain than the concentrations of the solid fraction. The liquid fraction also contains spent yeast and bacteria from the fermentation process. This thin stillage is normally processed by an evaporation process to condense the liquid to have between 30 to 50% of dry solids. At this elevated solids concentration, the material that is condensed is referred to as corn distillers solubles (CCDS) or syrup. The syrup can optionally be processed for the recovery of oil, as shown in the FIG. 2. In a typical dry grind plant, the centrifuged solids (DWG) and syrup are mixed and dried at a dryer, which produces DDGS. This material is often sold into the animal feed markets for feeding both ruminant and monogastric animals throughout the world. Although the DDGS often has more than 30% of protein, it is not suitable for making feeds for chicken and fish rations because the DDGS also contains a high percentage of fiber.

Some processes have been developed to improve the value and usage of distiller's material. For example, FIG. 3 shows a protein removal/recovery system as a way to improve the value of the distiller's material. The protein mixture that is recovered from the processes of FIG. 3 has 50% of protein and is good for poultry application. Even with this higher protein percentage, the proteins inside the corn are not fully digested inside the animals' gut. The not fully digested proteins are discharged in animal waste, which creates a lot of environmental issues, such as excessive nitrogen in the land. This not only increases the animal feeders' ration cost but also adds costs for manure waste treatment for the undigested nutrients.

Modern feeding employs enzymes, such as xylanase, cellulase, amylase, protease, and phytase plus direct fed microorganism (probiotic) in the animal feed formula. The enzymes in the animal feed hydrolyze polymeric feed molecules into smaller components, which enable the nutrients to be more easily absorbed by the gut. This technology allows the pig and poultry producers to lower feed costs, improve the nutritive uniformity of the feed, help maintain optimal gut balance and reduce environmental outputs of manure nutrients, such as nitrogen.

All the wet milling and dry grinding processes produce a type of syrup at the end of the process. This syrup contains the majority of the soluble minerals from grain along with unidentified growth factors (UGFs) that are mainly from dead yeast and micronutrients (e.g., vitamins and trace minerals).

Normally, the thin stillage has 4% to 9% of dry matter and is typically evaporated to contain approximately 30% to 50% of DS before the thin stillage is mixed with DWG. The combination of the condensed thin stillage and the DWG can be sold as DWGS. Alternatively, the combination can be dried and sold as a low cost DDGS. This material is mainly suitable for ruminant animal diets because the fiber and mycotoxin in the grain are higher than suitable for monogastrics.

Significant research and development work have been done to improve the value of thin stillage by increasing the content of the microbial protein by the aerobic growth of microorganisms. The thin stillage left over from the ethanol production contains biodegradable organic compounds and sufficient micronutrients that are an ideal feedstock for fungal cultivation, such as Rhizopus microsporus variant oligosporus. The fungus uses about 60% of the organic material for growth. Some of the compounds that are converted are undesired suspended solids and organic acids, which are undesirable for recycling. After growth, the fungal pellets can easily be harvested as a food-grade organism (RO), which is rich in fat and protein (e.g., the amino acids, lysine, and methionine). The capital costs and operating costs (primarily energy) needed for this system is high and cannot be justified on a commercial scale. Another impediment for this aerobic process is the need for USDA approval for animal feeding of Rhizopus microsporus variant oligosporus.

Many studies have shown the benefits of a high protein, low carbohydrate feed for animals of all kinds. The process described herein produces a low insoluble, low fiber, nutritive soluble stream that will be a suitable feed for young animals. Using this process, a soluble stream product contains a mixture of corn and yeast components that have high digestibility and perfectly suited for baby animals. After processing, this stream forms a mixture of amino acids, minerals and yeast components that provide a feed with many UGFs and other highly digestible nutrients. The soluble stream has the ability to be concentrated to contain 80% of solids. This high solid stream gives advantage of both increasing the shelf life by limiting growth of secondary organisms after production as well as lowering the transportation costs of this material to end users.

Baby swine and aquaculture feeding systems are able to use this highly nutritive soluble stream enhanced with UGFs to enhance weight gain for the growth of aquatic fish and algae. Algae becomes an excellent feed in itself for the larger organisms in the aquaculture system, including fish, crustaceans, shrimp, . . . etc. The algae growth contains proteins, fibers, fats and minerals that enhances the entire aquaculture ecosystem.

As shown in FIG. 5, the syrup is an ideal feed stock for propagation and growth of probiotic culture (generally around 10⁸ to 10¹⁰ CFU/g) and produce high lactic acid concentration (at times more than 20% lactic acid by dry matter basis). This enriched syrup can be mixed with WDG to produce enriched wet distiller's grain for local feed lot. The enriched syrup with around 20% dry matter lactic acid and probiotic (generally around 10⁸ to 10¹⁰ CFU/g) in liquid is not practical to be applied directly in dry feed system for the majority of feed lots. Because the enriched syrup in liquid form is difficult to be added to most feed lots for lacking the wet feed handling equipment.

As shown in FIG. 1, grain has been used to produce fuel alcohol and other co-products including gluten feed and gluten meal. This production has been performed for well over 30 years with particular emphasis on processing Maize (corn) as the raw material. The capital investment for the wet milling process is very high. Due to the high capital investment, most of the more recent (1990 and later) alcohol production processes built have been dry grind facilities.

A typical dry grind alcohol production process is shown in FIG. 2. In this process, the grain goes through a hammer mill (Step 2021), such that the grains are broken up to smaller particles sizes. This ground grain is mixed with cook water and an amount of amylase enzyme, such that the starch is liquefied by gelatinization and starch hydrolysis (Step 2022). This is followed by fermentation (Step 2023) to produce alcohol and distillation (Step 2024) for alcohol recovery. The material remaining after the alcohol recovery is whole stillage, which is normally sent to a device for and process of liquid/solid separation (Step 2025) to separate the solid (containing primarily insoluble materials mostly protein and carbohydrate, rich in fiber) and liquid (content mainly soluble materials and fine solids particularly rich in spent microorganism, particularly yeast). The liquid phase (thin stillage) is processed through an evaporator to economically remove excess water (Step 2027), which is followed by a process of optional oil recovery (Step 2026) to recover valuable vegetable oil. The (optionally de-oiled) syrup is mixed with cake from the process of liquid/solid separation (Step 2025) and is dried to produce DDGS byproduct as animal feed.

The DDGS generally has between 28% to 32% protein and 5% to 9% oil on a dry matter basis. However, because of the high fiber content, it is primarily used for ruminant rations and is not significantly included in swine, poultry, and aquaculture feeding rations.

An improved typical dry grind process is shown in the FIG. 3. This process adds several steps. These steps include 1) the process of oil/protein separation at Step 3031, 2) the process of protein dewatering at Step 3032, and 3) the process of protein drying at Step 3033. This process produces a high protein meal (around 50% of protein at a dry matter basis) from whole stillage with a low protein DDGS byproduct. One significant problem in the market is that 28% to 32% protein of a DDGS is over-produced in the USA, which results in a low profit product for the alcohol production industry.

One way to avoid the over-production of DDGS in the dry grind alcohol industry is to convert the fiber in DDG into alcohol. This is generally referred to as cellulosic alcohol. As shown in the FIG. 4, the fiber can be separated before the process of fermentation (Step 4041) or after the process of distillation (Step 4042).

After the fiber is converted to additional alcohol, the remaining material is depleted in fiber. The resulting whole stillage can be processed to produce a higher protein percentage of a protein feed that is able to be used for swine, poultry and fish rations. This protein feed has approximately 38% to 45% protein on a dry matter basis. If higher protein concentrations are desired, protein cake can be dried without syrup to produce a 50% (dry matter basis) or higher concentration protein meal. The syrup remaining has 16% to 20% of protein with soluble nutrients and an elevated concentration of spent yeast cells. This syrup can be used in many ways including to 1) grow microorganism(s) to produce a higher quality feed, 2) grow microorganisms to produce enzymes needed for the alcohol production process, 3) grow microorganisms to produce enzymes for the digestion of proteins and carbohydrates (rich in fiber) to make enhanced feed products, and 4) grow microorganisms to produce “antibiotic free” probiotic animal feeds that are rich in organic acids.

More details of the present disclosure are provided below:

Often, enzymes (e.g., xylanase, cellulose, amylase, protease, and phytase) are added to animal feed formulations. The activities of these enzymes hydrolyze polymeric and oligomeric components in animal feed, which increases the effective utilization of the nutrient components in the animals. In some embodiments, the microorganisms (probiotic) are also added to the animal feed formulations. The reasons that the probiotic added formulations are beneficial to the animal performance including: the probiotics produce molecules that are damaging to pathogens (e.g., organic acids like lactic acid, which compete with the pathogenic microorganisms for space and nutrients in the gut). The probiotic produces highly digestible proteins and express enzymes, some of which belong to the classes listed above.

Unfortunately, the addition of these beneficial components for animal feed is costly. It is beneficial to be able to add these activities into the feed material during feed production and formulation, which allows the enzyme activities to be fully performed on the components in the raw feed for producing a more valuable feed for animal performance.

FIG. 5C illustrates a dry milling process 50C of producing an enriched syrup in accordance with some embodiments. The dry mill process 50C includes syrup enrichment processes 5C02. In the syrup enrichment processes 5C02, a Step 5C29 of syrup enrichment is provided, at which culture of microorganisms or enzymes are added. The enriched syrup at the Step 5C29 contains around 20% of dry matter, lactic acid, and probiotic units (generally around 10⁸ to 10¹⁰ CFU/g). The enriched syrup at the Step 5C29 can be mixed with DWG cake and sent to DDGS dryer at a Step 5C28 of DDG drying. This process produces enriched DDGS with substantially elevated lactic acid. However, because of the high heat in the DDGS dryer (e.g., the Step 5C28) in some cases, the probiotic culture can, in some extreme cases, experience a high thermal log kill due to the high temperature of drying.

In some embodiments, a portion or all of the enriched syrup at the Step 5C28 (e.g., DDGS dryer) are sent to a DDGS cooling process of a Step 5C28A. At a Step 5C30, the enriched syrup from the Step 5C29 can be mixed with DDGS after the DDGS cooling process of the Step 5C28A. In some embodiments, the process of cooling DDGS of the Step 5C28A are used to avoid/prevent the high thermal death during drying.

In some embodiments, a dryer bypassing process 5C28B is performed. A fraction (0 to 100%) of the enriched syrup from the syrup enrichment process 5C29 (which bypasses or skips the DDGS dryer at the Step 5C28 and DDGS cooler at the Step 5C28A) preserves a large portion of the probiotic culture, which prevents the issue of thermal death and preserves other temperature sensitive materials (e.g., enzymes of the culture that are expressed into the enriched syrup.) The mixture of enriched syrup with DDGS after DDGS cooler of process 5C28A has a higher (more than 10% moisture) moisture content than a product from a typical process, which may affect the long-term storage and shipment of the material. In some embodiments, methods of shipping and material handling are used including, for example, excluding air during loading and shipping, minimizing time between production and use, adding preservative to entire material, adding preservative material at the surface of the shipping container where the enriched DDGS is in contact with air, and forming a protective layer on the outside of the pellet. FIG. 6 shows some embodiments of preservation processes.

The process disclosed herein for the production of enriched feed is described as an exemplary embodiment. The process is able to be applied to other products other than using the syrup from an ethanol plant.

FIG. 5B and FIG. 6 illustrate various ways of making the probiotic enriched animal feed in accordance with some embodiments. Each of the process steps in the FIGS. 5B and 6 are able to be combined with additional steps disclosed herein (e.g., processes disclosed in the FIGS. 5A, 5C, 7, 8, and 9) in various combinations as embodiments. In some embodiments, the factors to be selectively added to the steps and processes described in the FIGS. 5 and 6 including the length of storage, the distance of transportation, and amount of enriched DDGS needed.

FIG. 7 illustrates a method 70 of producing enriched feeds using wet mill or dry grind ethanol producing processes, devices, and systems in accordance with some embodiments. In some embodiments, a grinding mill at a Step 7072 of grinding grinds the protein cake, fiber cake, protein/fiber combined cake from the wet mill and/or dry grind processes (e.g., FIG. 1A, FIG. 2A, FIG. 3A, FIG. 4A and FIG. 4B) with added enzymes (e.g., xylanase, amylase, protease, cellulase and phytase).

The grinding mill at the Step 7072 disrupts bonds between protein and fiber, which increases the surface area contact between enzyme with protein and fiber. The grinding at the Step 7072 also aids the mixing of the solid materials and liquid materials. The probiotic culture, at the grinding of the Step 7072, speeds up the digestion process for protein and carbohydrates in the wet mill and dry grinding products.

FIG. 8 illustrates processes 80 of producing digested protein and carbohydrates in accordance with some embodiments. The digestion can be performed by adding enzymes and/or microorganisms that produces enzymes capable of digesting the protein and carbohydrates. The digested protein and fiber material can be sent to a) a dryer 802 for drying, b) an evaporator 804 for evaporating and followed by a dryer 806 for drying, or c) a liquid/solid separation process/device 808 for separating the liquid/solid and followed by using an evaporation 810 for evaporating and, next, to a dryer 812 for drying. In some embodiments, the predetermined content of the enriched feed material determines the processes to be used. For example, when a lower moisture content product is to be made, the drying time and/or drying temperature are able to be adjusted accordingly, in which a longer drying time or higher drying temperature.

In FIG. 4B, a super feed production process unit 4000B are included with a dry milling process 40B in accordance with some embodiments. In some embodiments, the protein and fiber cake material from the process of protein dewatering at a Step 4B32 is sent to the process of protein digestion at a Step 4B34, such that at least some of the proteins are digested to smaller protein fractions. Some materials in the process of protein digestion at the Step 4B34 are digested all the way down to amino acids and peptides. In some embodiments, the carbohydrase enzymes partially digest the carbohydrates. In some embodiments, the carbohydrase enzymes can also digest the carbohydrates all the way down to monomeric substances and oligomeric substances.

At a Step 4B43 of liquid/solid separation (after the process of protein dewatering at the Step 4B32), the digested mixture is sent to the process of solid/liquid separation. At the Step 4B43, the digested liquid (which contains small suspended particles and dissolved materials in addition to the newly soluble materials that are from protein and carbohydrate digestion) is separated from insoluble fine fibers and proteins.

At a Step 4B44 of evaporation, the liquid from the liquid/solid separation at the Step 4B43 is sent to a concentrating device, such as an evaporator, to concentrate the liquid portion up to as high as 80+% of a dry matter. This concentrated liquid can be optionally further dried to produce a high value powder, which is enriched in digestible proteins (including peptides and amino acids) and carbohydrate materials.

At a Step 4B33 of drying, the solid phase are sent a dryer at a Step 4B33, wherein the solid phase is from the evaporating of the Step 4B44 containing insoluble carbohydrates and proteins. After drying at the protein dryer of the Step 4B33, the solids can be used as an absorber (at a process of drying and absorbing of a Step 4B45) to absorb the enriched syrup to form a super feed (Step 4002B), which has digested protein and digested carbohydrate, including more absorbent enzyme treated fiber, high lactic acid, and probiotic characteristics.

FIG. 9 illustrates a semi-solid digestion system for producing enriched and digested probiotic feed in accordance with some embodiments. In some embodiments, dry protein and carbohydrate (rich in fiber) solid can be mixed with enriched syrup and various enzymes (such as xylanase, protease, amylase, cellulase, and phytase.) This mixture can be allowed to digest, as shown in a process 90 in FIG. 9 using a semi-solid digestion system. The protein/fiber material added into the process can be any number of dry materials including, but not limited to: DDG, DDGS, dry protein meal, gluten feed, and gluten meal.

The dry materials and semi-dry materials after digestion can be mixed with enriched syrup and various enzymes (such as, xylanase, protease, amylase, cellulase, and phytase), which is going through a pelleting process to form a pellet. The pellet can be used as a wet form for short time storage and short distance transportation.

Alternatively, the pelleting process can be done followed by one of many low temperature drying techniques/processes, such that the outside/surface of the pellet is just dry to the touch and the inside of the pellet has higher moisture content preserving the probiotic character of the feed.

In a FIG. 8, a variety of raw materials are used together with the process described in the FIG. 9. These include the use of (1) liquid phase whole stillage as shown in the process of FIG. 2B, (2) thin stillage, (3) syrup to propagate/grow microorganisms which produce all the enzymes needed for cost effective digestion of the poorly digestible protein and carbohydrate (rich in fiber), and (4) the production of the beneficial lactic acid and probiotic culture characteristics we desire/predetermined for an enriched feed value. This process allows reduced manufacturing cost as it can reduce, possibly to the point of elimination, the addition of exogenous enzymes from the process. This process allows the in-house propagation of enzymes and microorganism(s) for the final feed product.

In a FIG. 2A, a process 20A of generating an enriched syrup is provided. The thin stillage from the process of solid/liquid separation (Step 2A25) is processed by an evaporator at the process of evaporation (Step 2A27) to a concentration commonly between 20 to 40% dry solids. This semi-concentrated stream is then optionally sent to oil recovery (Step 2A26) to remove some of the oil for sale or further processing. The syrup (optionally, de-oiled syrup) is then used as a feed stock for propagation and growth of the probiotic culture (at the Step 2A29). This converts some of the carbohydrates lactic acid by a secondary fermentation process. The enriched syrup that contains a higher lactic acid concentration, with 20+% lactic acid on a dry matter basis observed and enriched probiotic unit (generally around 10⁸ to 10¹⁰ CFU/g) is mixed with DDG or DDGS from DDG drying at a Step 2A28 as an absorber to form high lactic acid probiotic feed supplement with around 30% to 40% moisture for local feed lot use.

In a FIG. 6, a method of producing probiotic feed by using an absorber to absorb the enriched syrup is provided in accordance with some embodiments. The high lactic acid probiotic supplement can go through a pelleting step followed by any number of low temperature dryer processes, such as fluidizing bed, to form hard, low moisture protect layer to keep the probiotic culture inside pellet alive/active while making for an easier to handle material, which is mostly dry on the outside.

In an aspect, a method of producing a probiotic animal feed in a wet milling or dry milling process comprising digesting protein and fiber in a cake by using one or more enzymes, forming digested protein and fiber containing fractions of the protein and fiber, and forming the probiotic animal feed.

In some embodiments, the enzymes are added exogenously. In other embodiments, the enzymes comprises xylanase, cellulase, amylase, protease, phytase, or a combination thereof. In some other embodiments, the enzyme is produced in the wet milling or dry milling process by propagating or growing one or more selected microorganisms. In some embodiments, the method further comprises breaking up bonds between the protein and the fiber using a grinding mill at the digesting.

In some embodiments, the grinding mill comprises a friction mill, a pin mill, a roller mill, or a cavitation mill. In other embodiments, the method further comprises adding a probiotic to the digested protein and fiber. In some other embodiments, the method further comprises forming an enriched syrup by adding one or more enzymes or one or more microorganisms to the digested protein and fiber. In some embodiments, the method further comprises mixing a dry DDG or an absorber with the enriched syrup. In other embodiments, the absorber comprises a popcorn, a poprice, or a pop-up grain. In some other embodiments, the absorber comprises a dried feedstuff material. In some embodiments, the absorber comprises dried grain screenings. In other embodiments, the dried feedstuff material comprises stover, straw, hulls, husks, wheat middlings, corn fiber, or cobs.

In some embodiments, the dried feedstuff material comprises a dry grain processing residue. In other embodiments, the method further comprises extending a shelf life of the probiotic animal feed by excluding air in the probiotic animal feed of a solid form. In some other embodiments, the method further comprises forming the probiotic animal feed into a pellet by drying under a low temperature at a dryer. In some other embodiments, the method further comprises drying an outside surface of a pellet forming a protective layer of the pellet while keeping inside moist so that an amount of probiotic culture stays alive inside of the pellet. In some embodiments, the dryer comprises a fluidizing bed dryer.

In another aspect, a method of producing probiotic supplement in a dry milling process comprises forming a cake from a process of liquid and solid separation after fermentation, enriching syrup and increasing the concentration of lactic acid by adding microorganisms or enzymes to the cake, forming enriched syrup, passing the enriched syrup through an environment having a temperature avoiding a high thermal condition killing more than 30% of probiotics in the enriched syrup, and forming the probiotic supplement.

In some other embodiments, the enriched syrup contains 16%-25% of dry matter, lactic acid, and probiotics between 10⁸ to 10¹⁰ CFU/g. In some embodiments, the method further comprises mixing a DWG cake with the enriched syrup forming a mixture, passing the mixture through a DDGS dryer, and passing the mixture through a DDGS cooling device avoiding death of the probiotics caused by a high temperature condition of the DDGS dryer. In some embodiments, the mixture after passing the DDGS cooling device has a moisture level higher than 10%. In other embodiments, the method further comprises avoiding a high temperature environment by bypassing a drying step and directly mixing the enriched syrup with a DWG cake. In some other embodiments, the method further comprises preserving and extending the shelf life of the probiotic supplement by excluding air from the probiotic supplement. In some embodiments, the method further comprises forming a protective layer by adding a preservative material on the surface of a pellet of the probiotic supplement. In some embodiments, the method further comprises adding a preservative material and mixing the preservative material with the probiotic supplement homogeneously.

In another aspect, a method of producing lactic acid and probiotic culture comprises performing a first fermentation and growing probiotics in a second fermentation by adding enzymes, adding microorganisms, providing an environmental suitable for a growth of the probiotics, or a combination thereof to a material from the first fermentation, such that a second fermented material is formed and forming a lactic acid and probiotic culture enhanced material.

In some embodiments, the material comprises whole stillage or a partial concentrated whole stillage. In other embodiments, the method further comprises performing culture separation on the second fermented material. In some other embodiments, the method further comprises performing drying using a dryer. In some embodiments, the material comprises thin stillage. In other embodiments, the method further comprises performing centrifuging the thin stillage. In some other embodiments, the method further comprises adding absorber to the second fermented material. In some embodiments, the method further comprises pelleting the lactic acid and probiotic culture enhanced material. In other embodiments, the material comprises syrup, syrup with mash, added sugar, or added sugar with added carbohydrates.

In another aspect, a method of forming probiotic material in a dry milling or wet milling process comprising performing a first fermentation at a first fermenting tank, forming an enriched syrup, adding an absorber to an enriched syrup and forming the probiotic material in form of a flowable solid.

In some embodiments, the method further comprises forming an air isolating layer by adding a preservative on a surface of the flowable solid. In other embodiments, the method further comprises adding and evenly mixing a preservative with the flowable solid. In some other embodiments, the method further comprises forming a vacuum pack.

In other embodiments, the method further comprises passing the flowable solid through a dryer. In some other embodiments, the method further comprises pelleting the flowable solid

### BRIEF DESCRIPTION OF DRAWING

Typical Processes

FIG. 1 is a typical wet mill process.

FIG. 2 is a typical dry grind alcohol process.

FIG. 3 is a typical dry grinding process with protein recovery.

FIG. 4 is a typical dry grinding process with a secondary alcohol production.

FIG. 5 is a typical dry grinding process with enriched syrup production step.

### Selected Embodiments

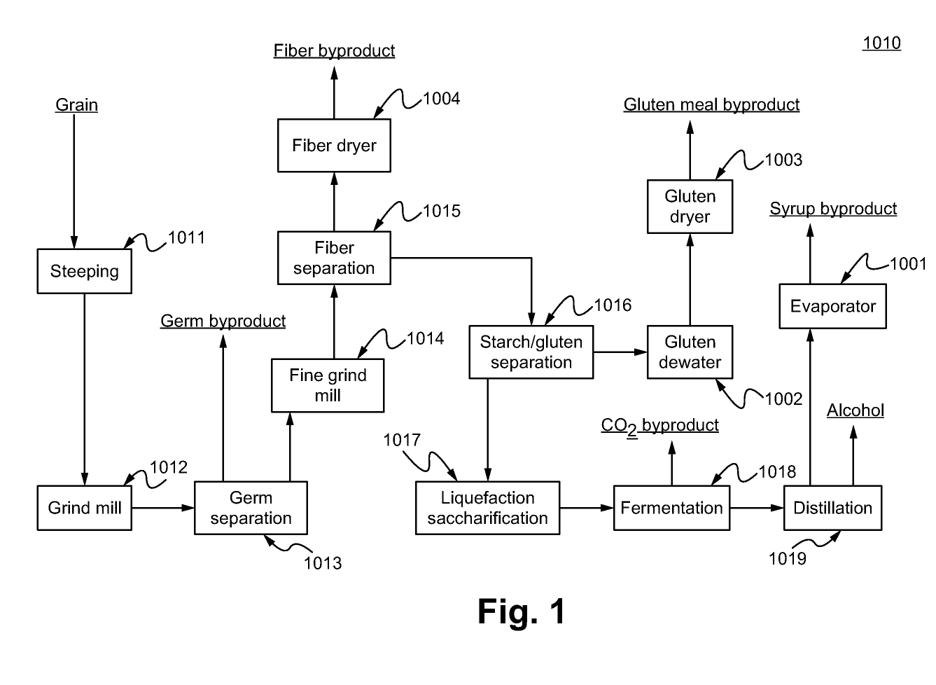

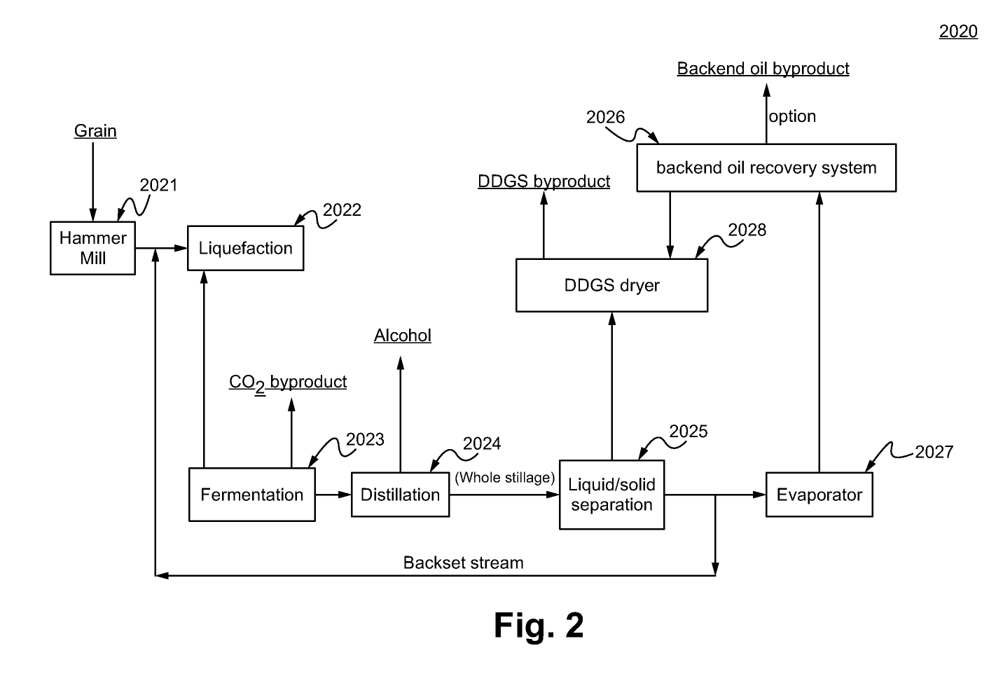

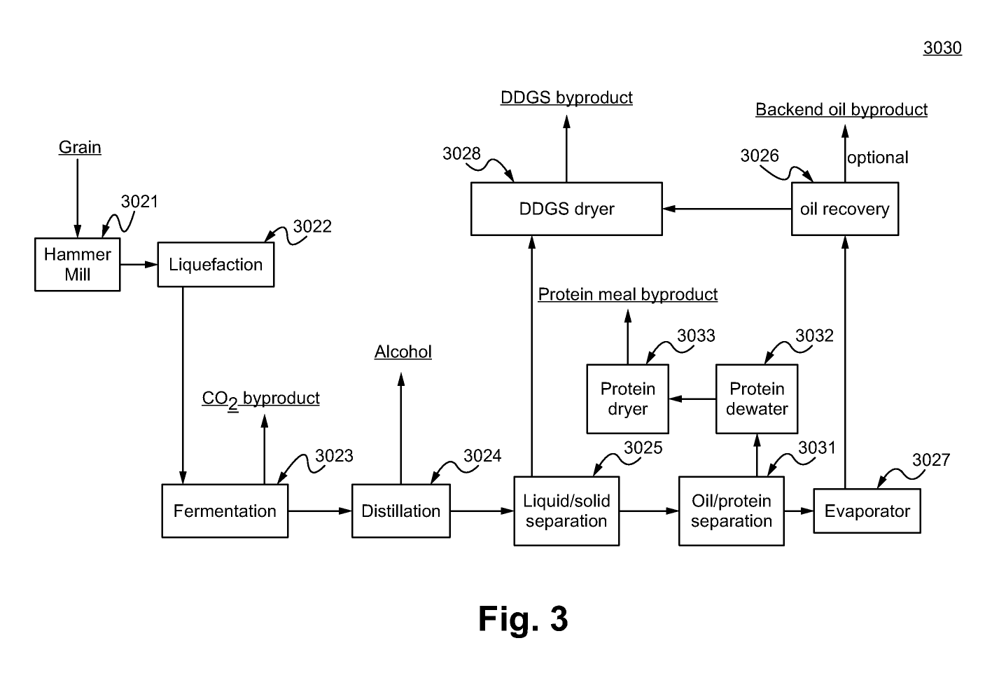

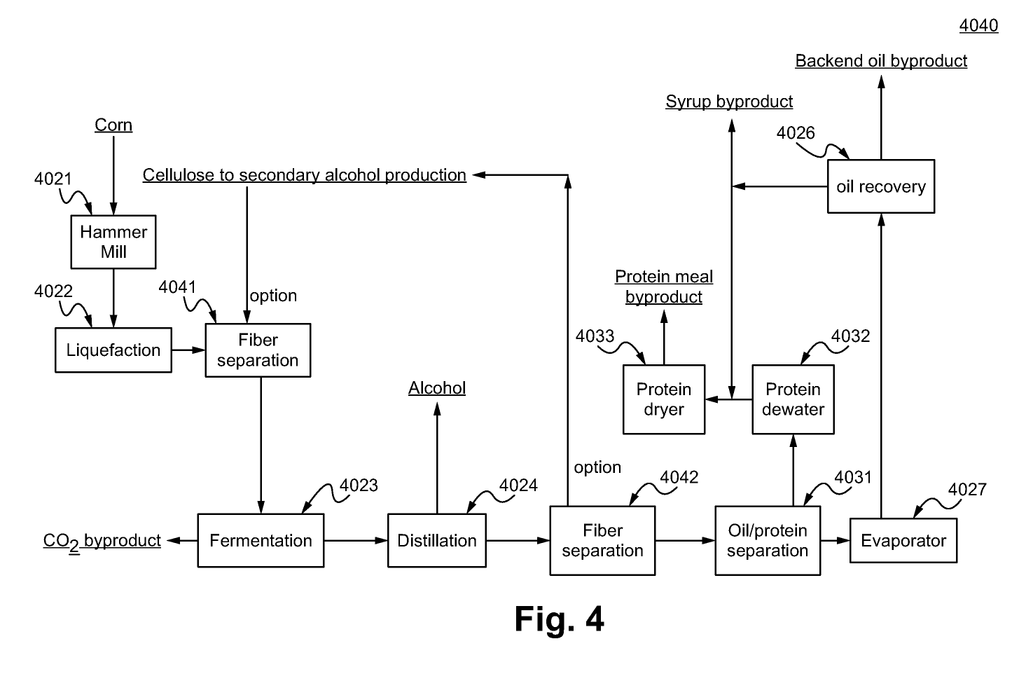

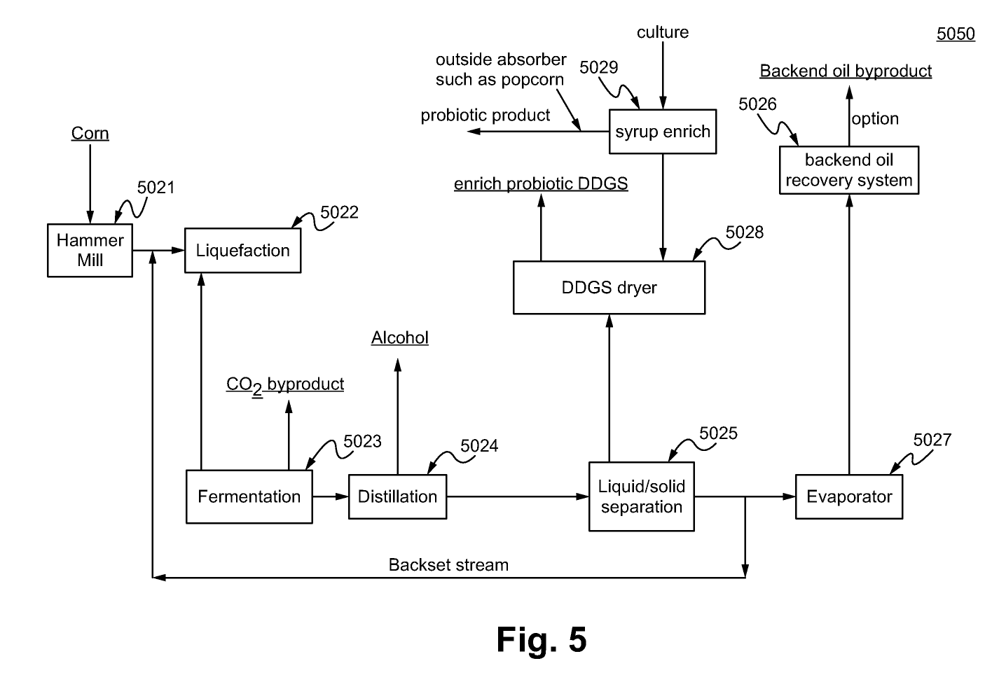

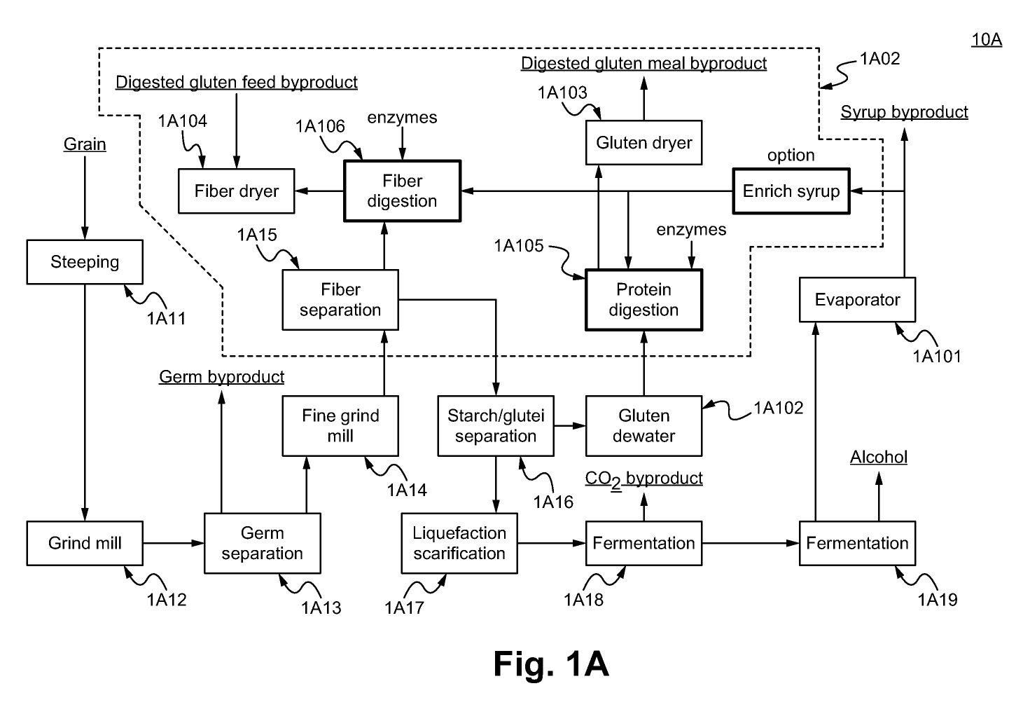

FIG. 1A illustrates a wet milling process with the protein/fiber digesting process in accordance with some embodiments.

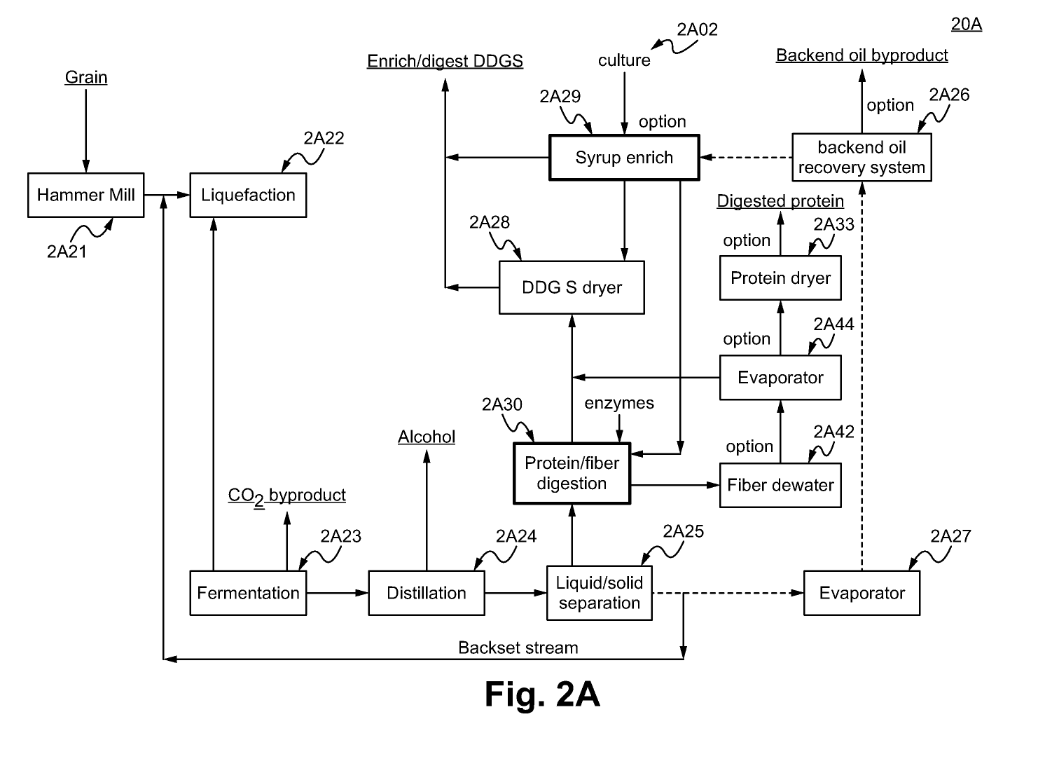

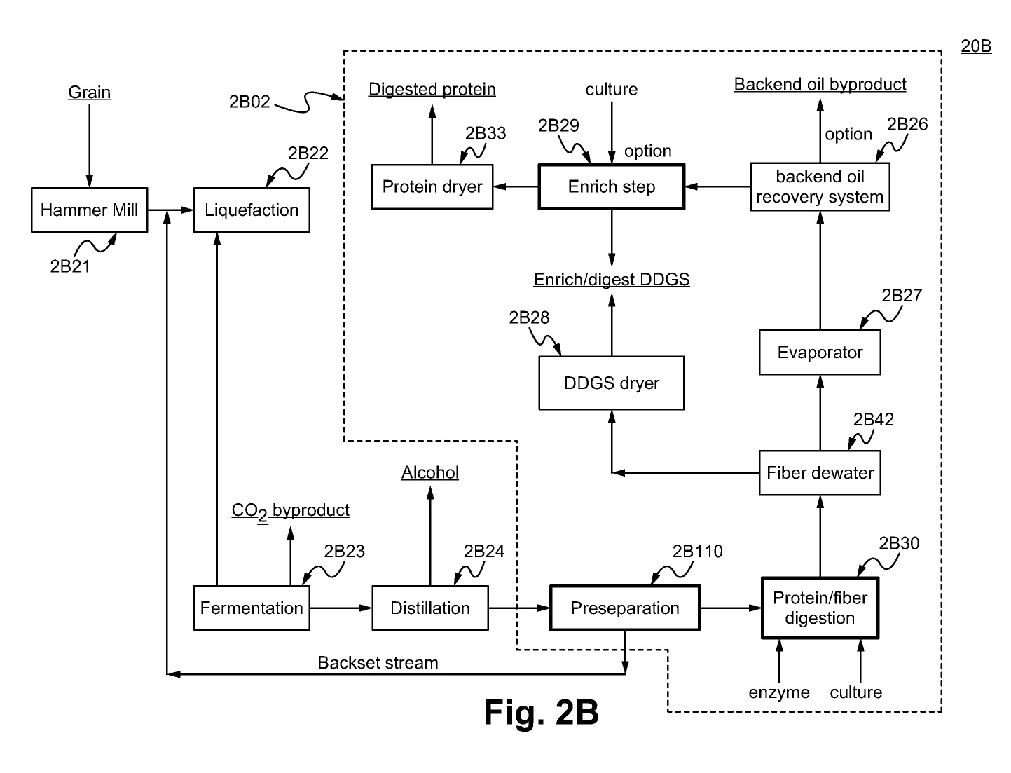

FIG. 2A illustrates a dry grinding alcohol process with a protein/fiber digesting process and an enriched syrup in accordance with some embodiments.

FIG. 2B illustrates another dry grinding alcohol process with a protein/fiber digesting process and an enriched syrup in accordance with some embodiments.

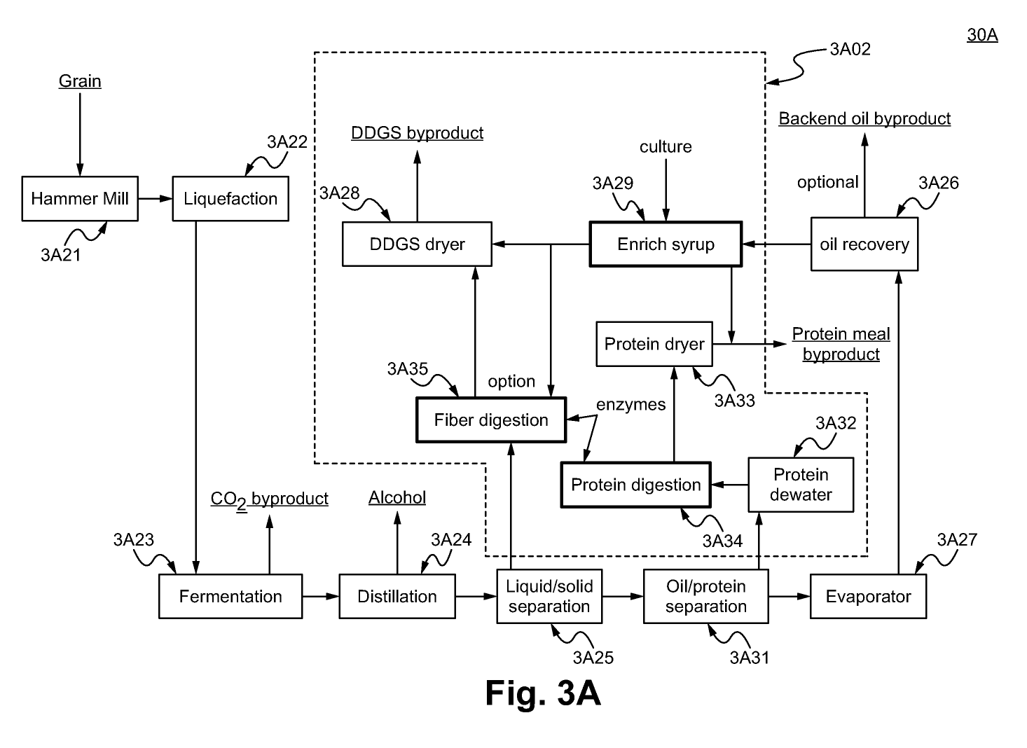

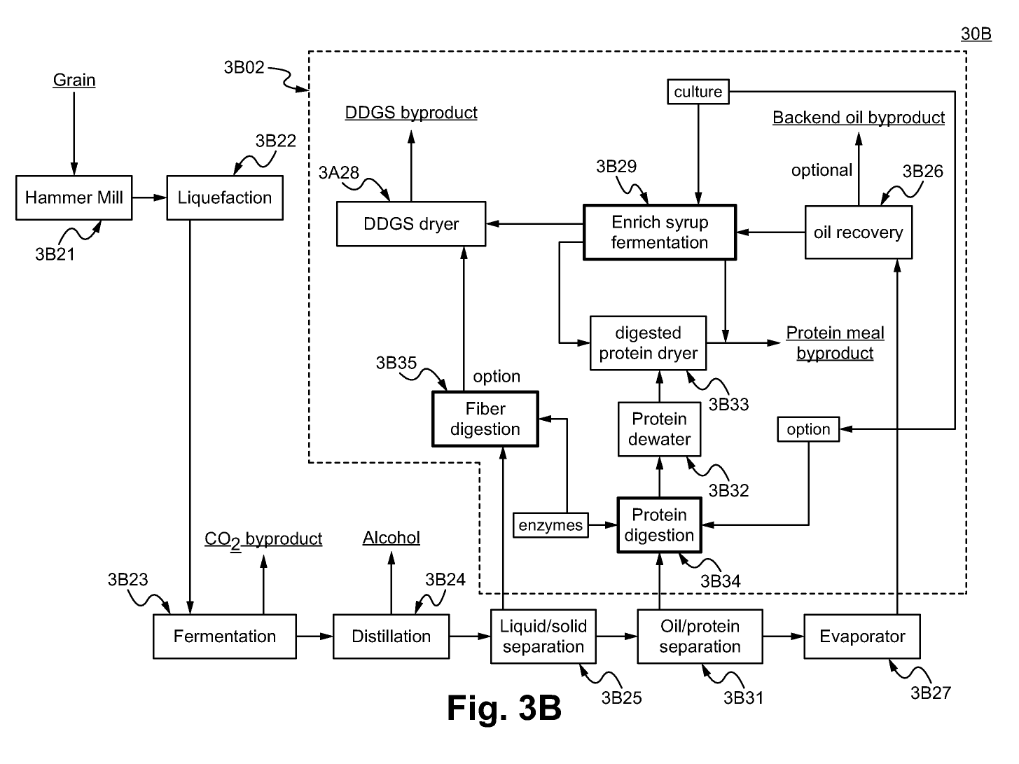

FIG. 3A illustrates a dry grinding process with a protein recovery process, protein/fiber digesting process, and using an enriched syrup in accordance with some embodiments.

FIG. 3B illustrates a dry grinding process with a protein recovery process, a protein/fiber digesting process, and using an enriched syrup in accordance with some embodiments.

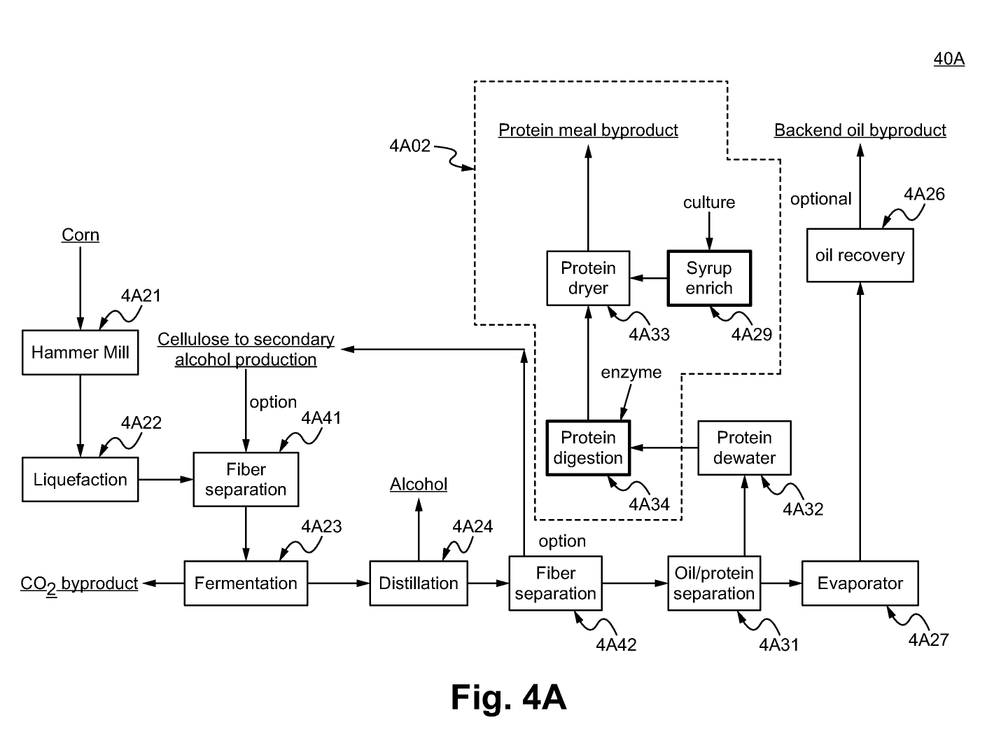

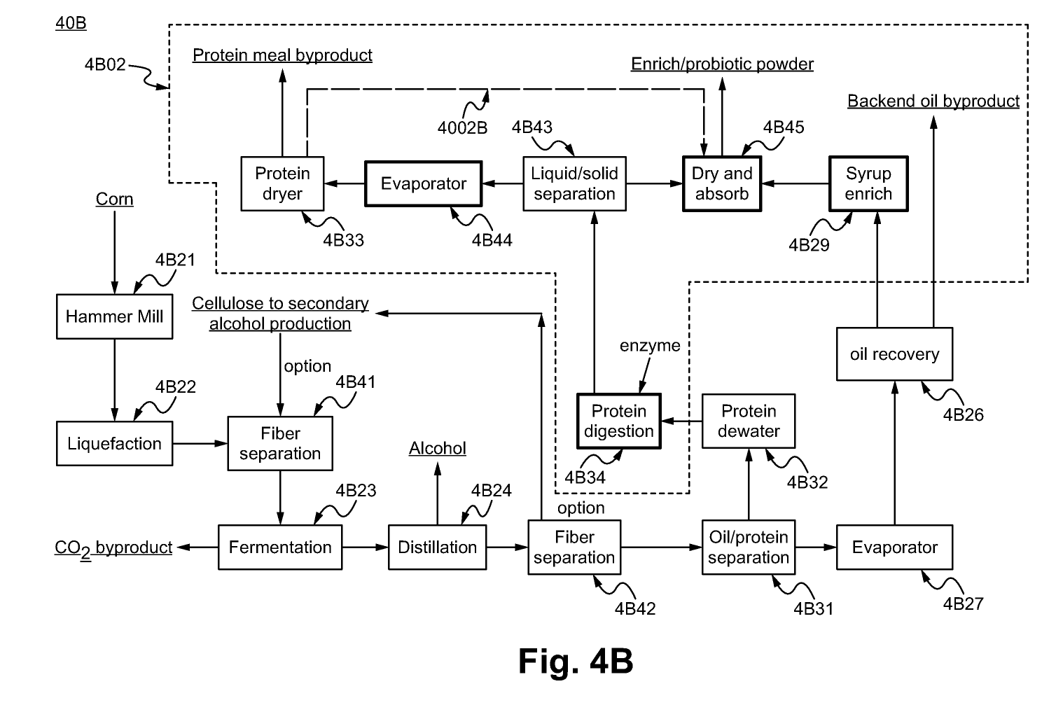

FIG. 4A illustrates a dry grinding process with secondary alcohol production in conjunction with a protein/fiber digesting process and using an enriched syrup in accordance with some embodiments.

FIG. 4B illustrates a dry grinding process with a secondary alcohol production in conjunction with a protein/fiber digesting process and using an enriched syrup in accordance with some embodiments.

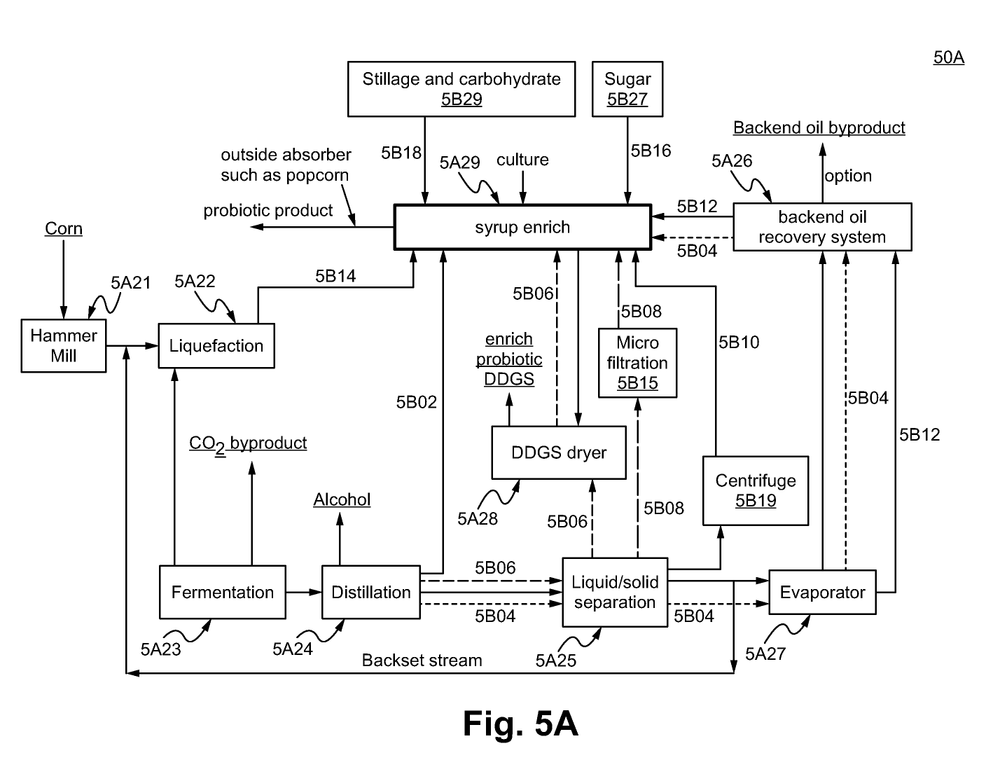

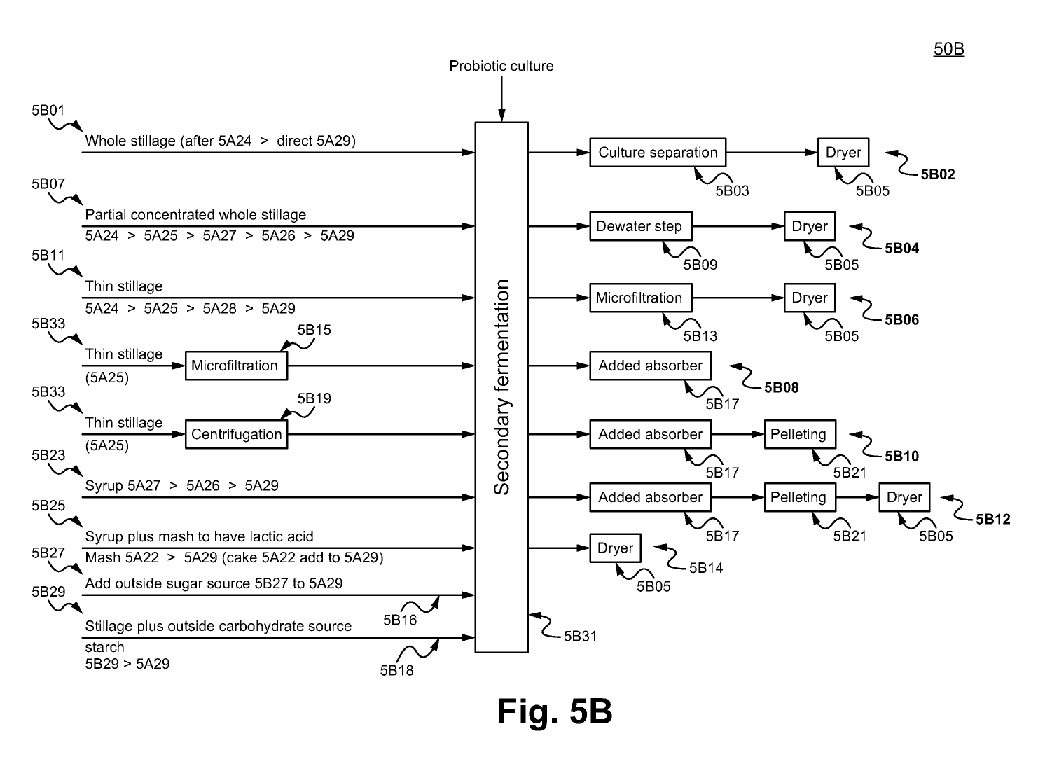

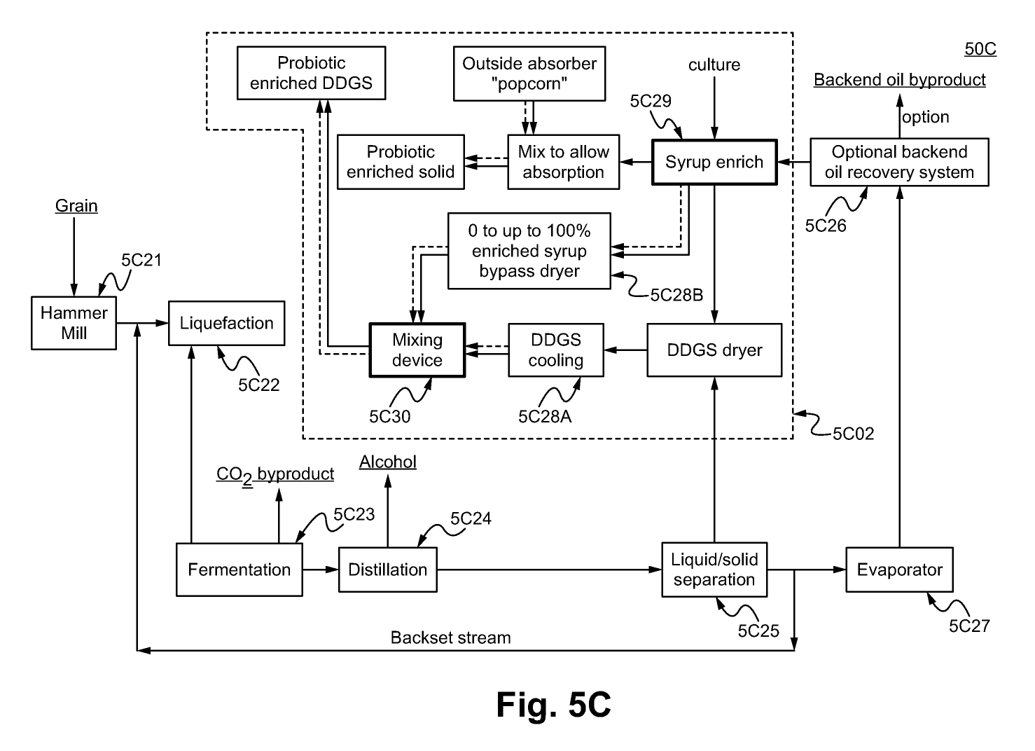

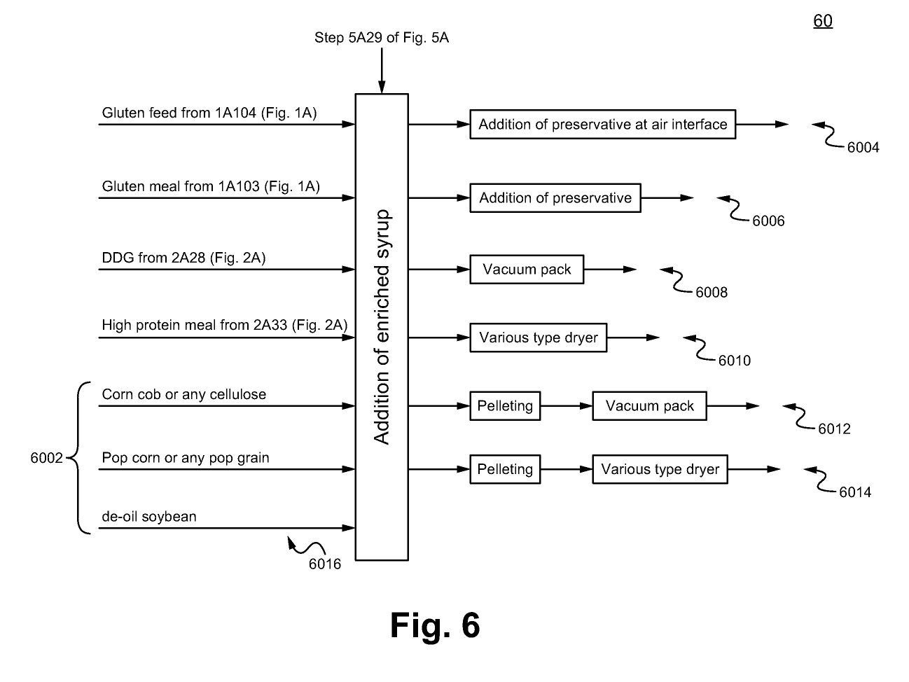

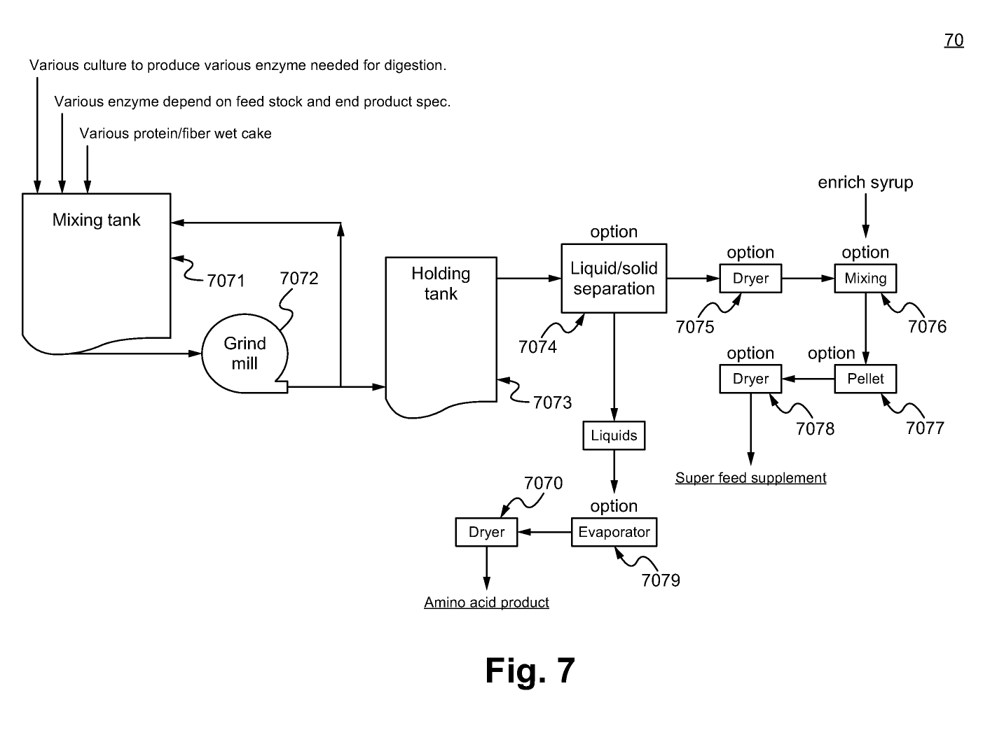

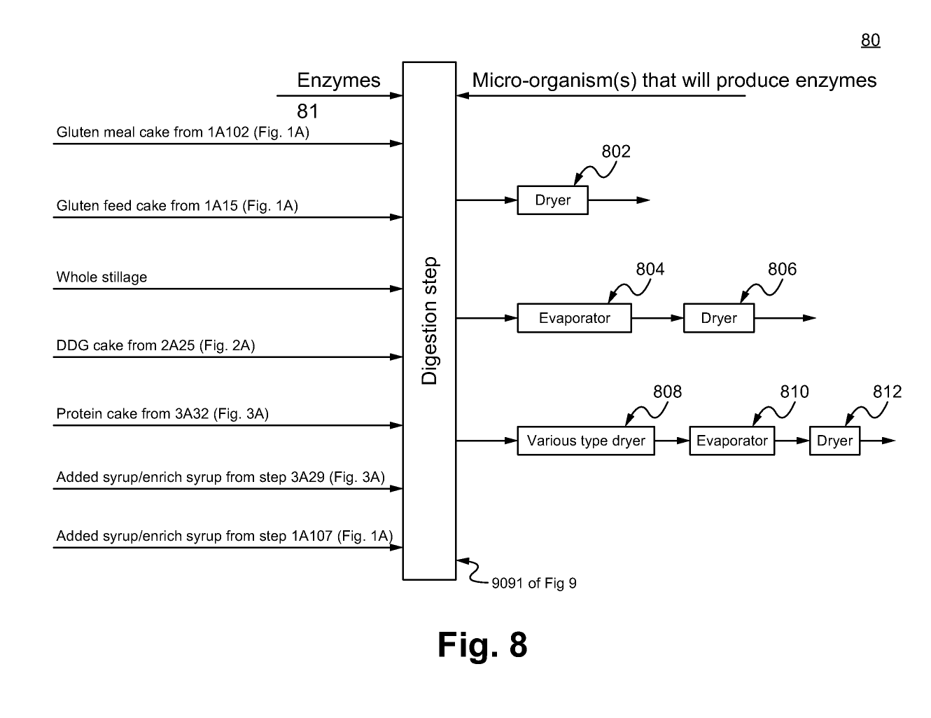

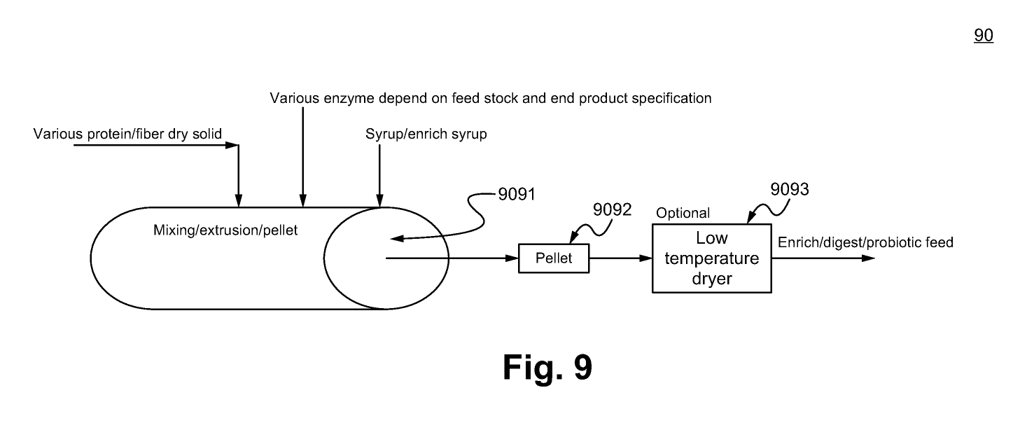

FIG. 5A illustrates processes of producing probiotic supplement in accordance with some embodiments.

FIG. 5B illustrates processes of using various feed stock source for the production of probiotic supplement in accordance with some embodiments.

FIG. 5C illustrates processes of producing probiotic supplement in accordance with some embodiments.

FIG. 6 illustrates various sources of absorber to absorb enriched syrup and produce solid probiotic supplement in accordance with some embodiments.

FIG. 7 illustrates a digestion system for digesting the protein/fiber in accordance with some embodiments.

FIG. 8 illustrates processes for producing the “super feed” using a protein/fiber digesting process in accordance with some embodiments.

FIG. 9 illustrates a semi-solid digestion in accordance with some embodiments.

### DETAIL DESCRIPTION OF THIS INVENTION

In some embodiments, microorganisms are conditioned to quickly propagate spent stillage in an alcohol production plants. Examples of these materials include steeping liquid, whole stillage, thin stillage and syrup. In some embodiments, the microorganisms have been selected, including from the Lactobacillus family, which produce desired metabolites in the secondary fermentation. Minor adjustment to the stillage conditions is sufficient to allow rapid growth of these microorganisms because of the rich nutrition content found in stillage streams from both wet mill and dry grind alcohol facilities.

In some embodiments, whole stillage, thin stillage and syrup are used as a cheap medium source, which is able to be used for the production of probiotics and enrichment of animal feed ingredients with high organic acid(s) content.

FIG. 5A illustrates a dry milling process 50A for alcohol production with enriched syrup process in accordance with some embodiments. In the FIG. 5A, the syrup in the process of syrup enrichment at a Step 5A29 can be used as feed stock to propagate probiotic microorganisms (e.g., Lactobacillus plantarum, Lactobacillus amylovorus, Lactobacillus mucosae, and Lactobacillus fermentum). This fermentation converts a signification fraction of the organic material to lactic acid and probiotic at 1×10̂8 to 1×10̂10 CFU/gram. This enriched syrup can be used to feed the animal, which improves animals' digestion system and the performance of the immune system. In some embodiments, the enriched syrup is used as part of an enriched lactic acid and probiotic feed supplement for all types of animal diets. This enriched syrup can also be used as soil conditioning/enrichment.

A large number of raw materials can be used as the feed stock for the syrup enrichment process at the Step 5A29, which can be incorporated into typical alcohol production facilities.

FIG. 5B illustrates a process 50B using a secondary fermentation for producing lactic acid and probiotic culture in accordance with some embodiments. The descriptions and drawing of process 50B can be read together with the descriptions and drawings of process 50A of FIG. 5A. FIG. 5B illustrates that various materials in the alcohol production process is used a feedstock for producing lactic acid and probiotic culture. For example, whole stillage 5B01, partially concentrated whole stillage 5B07, thin stillage 5B11, partially concentrated thin stillage 5B33, syrup 5B23, syrup with addition mash 5B25, stillage with outside carbohydrate addition 5B29, and addition of other sugar source from outside 5B27 are all suitable and are used for the creation of enriched feed products in accordance with some embodiments. Thus, any materials that can be used in the secondary fermentation 5B31 (e.g., after a first fermentation at a Step 5A23 in the FIG. 5A) is within the scope of the present disclosure. The materials disclosed in the process 50B are able to be used with the process 50A (e.g., at the Step 5A29 of syrup enrichment) in accordance with some embodiments.

In an embodiment, the enriched syrup with 20% to 40% dry solids basis at the Step 5A29 has approximately up to around 20% solids lactic acid on a dry solids basis and around 10̂8 to 10̂10 CFU/g unit on an as-is basis. In some embodiments, the probiotic activity in the enriched syrup has up to one year of shelf life. This can be directly added to animal feed immediately before feeding with an in-line mixing process. It can also be added to wet feed such as WDG, wet grain feed system.

FIG. 6 illustrates a method 60 of producing probiotic feed by using absorber to absorb the enriched syrup (e.g., the syrup enrichment at the Step 5A29 of FIG. 5A) in accordance with some embodiments. The enriched syrup can be mixed with wet mill derived protein/fiber cake (gluten feed cake (e.g., gluten feed cake from the Step 1A104 of FIG. 1A) and gluten meal cake (e.g., the gluten meal cake from the Step 1A103 of FIG. 1A)). The enriched syrup can also be mixed with products from dry grind alcohol production, such as DWG, DDG, DDGS, and protein cake that can be from the Step 2A28 of FIG. 2A. The enriched syrup can also be applied to other feed ingredients as solid absorbents 6002 of almost any kind including high fiber roughages such as corn stover, soybean protein, and soybean hulls. The resulting material (enriched syrup) can be preserved in a variety of ways including: chemical preservative, vacuum packing, low temperature dryer, pelleting, and pelleting with surface drying. Any other proper preservation methods and materials are within the scope of the present disclosure. In some embodiments, the drying is conducted at a temperature low enough to avoid killing probiotic organisms as well as inactivating growth factors and active enzymes. In some embodiments, suitable dryers include fluid bed dryers and flash vacuum dryers.

In some embodiments, the enriched syrup has moisture of 60% to 80% and the finished fermentation broth can be kept with high probiotic culture survival for several months at room temperature. Lowering the temperature to near 4 degrees Celsius significantly extends the shelf life of the probiotic culture. Dry feed ingredients, such as grain, for animal feed need less than 16% moisture for long term-storage. Application of enriched syrup can be made to a variety of dry feeds (FIG. 6) including: 1) animal feed from wet milling, such as feed from gluten feed process 6004, feed from gluten meal process 6006, or feed from corn fiber process 6012, and 2) animal feed from dry grind, such as DDGS at process 6008, and high protein meal at process 6010, and 3) other common dry animal feeds such as cotton seed meal, corn flour, deoiled soybean at process 6016, soybean hull, wheat grain, popped grains at process 6014 (such as popcorn and popped rice), plant waste (such as corn cob, rice hull, and wheat bran at process 6012).

In some embodiments, the solid animal feed is used as a stabilizing absorber. In some embodiments, the absorber acts as a carrier for the enriched syrup allowing the outside of the absorber to be dry to the touch while keeping the inside at a higher moisture content. The higher moisture content better preserves the probiotic culture while also reducing oxygen contact with the probiotic lowering spoilage.

Excellent results of probiotic stability have been shown with a 1 to 1 syrup to absorber ration, though other ratios have excellent benefit as well. In some embodiments, the absorber and enriched syrup are mixed with a 1 to 1 by weight ratio, which gives a flowable solid with moisture content of 30 to 40% while preserving a 1×10̂8 CFU/g probiotic value. In some embodiments, the material can be added to dry feed applications with in-line mixing at an inclusion rate of commonly between 1 to 10 kg per metric ton of feed. In some embodiments, the inclusion rate is adjusted based on the nutritionist desire in the field for final formulation.

In some embodiments for making long-distance or long-time storage, the mixture is packed in vacuum and/or refrigerated. This greatly extends the shelf-life of the product. High heat and humidity would shorten the shelf life. In some embodiments for increasing the shelf-life without refrigeration, pelleting is performed to minimize air contact and decrease the rate of spoilage. In some embodiments, low temperature drying is performed to produce a dry outside surface of pellet and keep inside pellet moisture above 30%. If the moisture content drops below 30%, survival of the probiotic organism is compromised. In some embodiments, the moisture content is kept above 30% in the preservation process.

The enriched syrup process (as shown in FIG. 5) is disclosed in the provisional patent application No. 62/184,768 on Jun. 25, 2015 with a title of “A System to Produce a High Value Animal Feed Additive from Stillage on Alcohol Production Process,” which is incorporated by reference in its entirety for all purposes. In some embodiments, enriched syrup produced in the various industrial processes (e.g., the alcohol production processes and plants) is applied to the feed industry for the flexible formulation of feed ingredients with extended shelf-life, particularly party dried feeds.

### Digestibility of the Protein

In another aspect, the concentration of crude protein has been used as an important nutritive indicator for animal feed ingredients. However, crude protein does not reflect the digestibility of the protein. Protein needs to be digested to amino acids by the animal in order for absorption and useful utilization by the animal. Amino acids are the constituent elements of protein and are essential for muscle growth. Modern poultry operations require more and more rapid growth for commercial competitiveness. The protein content in most alcohol co-products poor protein digestibility with only about 50% of protein from these sources being digested throughout the poultry gastrointestinal tract. Undigested protein is excreted as animal waste resulting in excess manure handling costs.

In order to increase poultry digestibility feeders mix protein digestive enzymes—particularly proteases—into the feed before being fed to animals. In some embodiments, the protein digestibility is processed, conditioned, and improved by 3.5% to 10% and facilitate reduction of protein content in feed diets by 1% to 2% depending on feed and enzyme efficiency Improving protein digestibility reduces manure nitrogen excretion, which can cause environmental pollution and endangers aquaculture. It is estimated that 52% to 95% of nitrogen source added to the marine fish culture system as food will ultimately become pollution in the environment, which is an issue that can be solved by the embodiments disclosed herein.

Phytic acid is a saturated 6 carbon ringed cyclic acid with an inositol in the middle and six phosphates surrounding it and having a chemical formula of C₆H₁₈O₂₄P₆. It is the main storage form of phosphorus in many plant tissues and is especially abundant in bran and seeds. It has strong chelating properties for divalent and trivalent cations. This chelating ability can tie-up/bind necessary minerals, such as zinc and iron during digestion, which results in the need for adding additional minerals to the animal diet. Phytic acid can also be found in cereals and grains. Despite its richness in phosphorus, phytic acid is generally not bioavailable to non-ruminant animals. Phosphorous, inositol and chelated minerals from phytic acid is effectively made bioavailable by the action of the enzyme phytase. Monogastric animals do not have the ability to produce significant phytase. Because of this, modern feed diets are incorporating phytase into the feed before giving this to the animal to convert more of the phytase to phosphorous thus increasing the absorption of the phosphorous in the feed stuff while reducing the amount of phosphorous in the manure.

In most commercial agriculture, non-ruminant livestock, such as swine, poultry and fish, are fed mainly with grains, such as corn, legumes and soybeans. Because phytic acid is unavailable for digestion and absorption, the majority of phytic acid will pass through the gastrointestinal tract and be excreted in the manure, which increases the amount of phosphorus in animal wastes and poses a serious environmental pollution problem, particularly where livestock runoff can enter water ways. Phosphorus is important for animal metabolism and plays an essential role in livestock growth and reproduction. Because of the unavailability of phytic acid, inorganic phosphates must be added into feed to meet phosphorus requirements, which results in tremendous costs. Many enzyme companies market phytase products or a cocktail of enzymes containing phytase to be used as animal feed supplement in order to enhance the phosphorus availability of feed to animals and increase nutrient uptake.

Phosphatase is a category of enzymes that removes phosphate group from its substrate. Phytase, a type of phosphatase, can catalyze the hydrolysis of phytic acid and release inorganic phosphorus in the form of phosphate making the natural phosphorous found in feedstuffs with phytic acid readily bioavailable and easy for the animal to absorb. Hydrolysis of phytic acid and subsequent absorbance of inorganic phosphorus by the animal means less expenses on adding inorganic phosphorus, less excretion of phosphorus in the manure and less environmental hazards and pollution. Adding phytase into animal feed as a feed supplement not only can reduce environmental impact but also can increase the amount of available phosphorus, which enhances the nutritive value of plant material by freeing of inorganic phosphate from phytic acid. Thus, Phytase is added to the animal feed as a supplement in accordance with some embodiments.

In some embodiments, various enzymes are added to facilitate the conversion of large moleculares into biologically accessible simple compounds to improve industrial efficiency and enhance feed efficiency in accordance with some embodiments. Commonly used enzymes in agriculture industries are within the scope of the present disclosure. The enzymes include cellulase (e.g., hydrolyze cellulose into glucose), Xylanase (e.g., hydrolyze xylem (a form of hemicellulose that bound cellulose together) into digestible five-carbon sugars), Xylem or hemicellulose (e.g., a highly abundant fiber type in grains), and amylase (e.g., the most commonly used enzyme in grain processing and hydrolyzes starch into glucose). One or more of these enzymes hydrolyze macro molecules and convert them into biologically accessible simple compounds to improve industrial efficiency and enhance feed efficiency.

As described, current practices in animal feeding practices mix feed ingredients with commercially available concentrated or purified enzymes in order to increase the digestibility for the animal. However, sterile production, purification, concentration, stabilization, storage and shipment of enzymes require tremendous investment, high operating costs and sophisticated operation. These factors result in high cost for enzyme products and, therefore, raise the cost of feed for farmers resulting in lower profits and higher costs for all involved.

One inherent problem with adding enzymes into the feed just before delivery to the animal is the low efficiency of the process. Enzymes require certain water activity, pH and time for effective hydrolytic activity. These conditions are not found in the general storage conditions for animal feed diets. As such, the common practice is adding enzymes in feed just prior to be feed to or ingested by the animals. However, the enzyme activity time inside the animal digestion system is very short, and the conditions are generally not in optimum conditions for enzyme with the pH particularly outside of optimal range. This short retention time and poor pH range result in the need for loading significantly higher enzyme amount to effective hydrolyze the macromolecules for food purposes.

A better process is to perform the enzyme hydrolysis outside the body of the animals while capable of controlling the pH, temperature, and water activity values that are favored by the enzyme(s). In some embodiments, selection of the proper enzymes and incubation of the feed ingredients with the useful macromolecules at the industrial production facility are performed, which produces higher value/nutrient animal feed for the animal feed market. Performing this hydrolysis on the protein/fiber stream inside the wet milling and dry grinding process and controlling process conditions to give optimal enzyme digestion capability to produce optimized digested protein/fiber for various age and type of animal are performed in accordance with some embodiments.

FIG. 1A illustrates a wet milling process 10A for alcohol production with a protein digestion process 1A02 in accordance with some embodiments. The substance from the process 10A of protein digestion at a Step 1A105 is used to digest the gluten meal wet cake, which comes from a vacuum drum filter at a gluten dewatering at a Step 1A102. The fiber digesting of a Step 1A106 is performed to digest the fiber press cake, which comes from a process of fiber separating of a Step 1A15, which uses a press. The process of fiber separating of the Step 1A15 can use a typical wet milling process described in the FIG. 1. The addition of these enzyme activities at these stages results in effective use of enzyme for the lowest cost and highest net effectiveness, which significantly increases the value of these products in animal diets, particularly in monogastric diets.

FIG. 2A illustrates a dry milling process 20A for alcohol production with an enriched syrup and digestion process 2A02 in accordance with some embodiments. The protein/fiber digesting at a Step 2A30 is used to digest the protein and fiber in wet distiller grain cake, which comes from a process of liquid/solid separating at a Step 2A25. At a Step 2A29, a process of syrup enriching is used to produce lactic acid and probiotic culture from syrup, which comes from a process of de-oiling/backend oil recovering at a Step 2A26. The combination of both digested protein/fiber meal and the enriched syrup to form the enriched and digested DDGS high value feed on typical dry grind process.

FIG. 2B illustrates another dry milling process 20B with an enriched syrup and digestion process 2B02 in accordance with some embodiments. As show in the FIG. 2B, a process of protein/fiber digesting at a Step 2B30 is used to digest the protein and fiber in whole stillage, which comes from a process of distilling at a Step 2B24. The process described in the FIG. 2B generates a higher digestion protein yield. The process described in FIG. 2B is suitable for a process with higher costs of operation.

FIG. 3A illustrates another dry milling process 30A with a protein recovery, an enriched syrup and a digestion process 3A02 in accordance with some embodiments. As show in the FIG. 3A, a process of protein digesting at a Step 3A34 is used to digest the protein cake obtained from a process of protein dewatering at a Step 3A32. In some embodiments, the conditions are maintained, such that enzyme hydrolyzes the protein and produces a high value digested protein meal. In some embodiments, the process of syrup enriching at a Step 3A29 is used to produce lactic acid and probiotic from syrup either with or without the process of de-oiling, which is able to be an oil recovering at a Step 3A26. The enriched syrup is mixed with DDG to form an enriched DDGS on a dry grinding process.

FIG. 3B illustrates another dry milling process 30B with a protein recovery, an enriched syrup and a digestion process 3B02 in accordance with some embodiments. As show in the FIG. 3B, a process of protein digesting at a Step 3B34 is used to digest the protein before a process of dewatering at a Step 3B32. The process described herein allows for higher moisture concentrations during the enzyme digestion for better mass transfer and enzyme activity. This higher moisture content also allows the application of optional microbiological culture growth. The introduction of microbial fermentation allows the microbes to grow and produce enzymes. These enzymes can then act on the protein mixture lowering the demand for exogenous enzyme purchase. The combination of the higher water content, better enzyme mass transfer, and optional microbiological culture allows for hydrolysis that produces a high value digested protein meal.

In some embodiments, the syrup enriching at a Step 3B29 is used to produce lactic acid and probiotics from syrup either with or without the process of de-oiling, which is at an oil recovering at a Step 3B26. This enriched syrup is then mixed with DDG to form an enriched DDGS on a dry grinding process.

FIG. 4A illustrates another dry milling process 40A with a secondary alcohol production having a protein recovery and an enriching syrup process 4A02 in accordance with some embodiments. As show in the FIG. 4A, a process of protein digesting at a Step 4A34 is used to digest the protein cake from a process of protein dewatering at a Step 4A32, which produces a high value digested protein meal. In some embodiments, the syrup enriching at a Step 4A29 is used to produce lactic acid and probiotic from syrup either with or without the process of de-oiling at an oil recovering at a Step 4A26. This enriched syrup is then mixed together to form a high value enriched protein meal.

FIG. 4B illustrates another dry milling process 40B with a secondary alcohol production with a process of generating super food byproduct 4B02 in accordance with some embodiments. As show in the FIG. 4B, a process of protein digesting at a Step 4B34 is used to digest the protein cake from a process of protein dewatering at a Step 4B32. The digested stream is send to a process of liquid/solid separating at a Step 4B43, such that the amino acids, peptides and soluble proteins in a liquid phase are separated from insoluble digested fiber and insoluble digested protein in the solid phase. The amino acid, peptides and soluble proteins can be further concentrated in the evaporator at an evaporating Step 4B44. The resulting concentrate can be dried in a suitable dryer, such as a spray dryer at a Step 4B33 to produce high value amino acid, peptides and soluble protein feed ingredient for baby animal and fish. In some embodiments, the process of syrup enriching at a Step 4B29 is used to produce lactic acid and probiotics from syrup either with or without the optional process of de-oiling at an oil recovering Step 4B26. The solid phase from the liquid/solid separating at a Step 4B43 can be dried and used as absorbent for the enriched syrup to produce high value enriched digested probiotic feed.

FIG. 7 illustrates a digesting system 70 in accordance with some embodiments. The wet protein, fiber cake, and/or enzymes are selected to be added to a mixing tank at a process of mixing at a Step 7071. After mixing the material, the process is followed by a shearing or grinding device at a grinding Step 7072 (e.g., Superton or disk mill to break up the interaction bonds between protein and fiber and to break up the material into smaller particles to increase the contact surface area, such that the process of digesting can be sped up. The material exiting the grinding system can be partially recycled back into the mixing tank to keep the incoming feed free flowing. The remaining fraction of the ground material is transferred to the holding tank at a holding Step 7073. The material is incubated in the holding tank for between 5 minutes to 100 hours, more preferably between 2 hours and 50 hours, to complete the digestion. When the digestion is deemed sufficient, the stream is sent to a process of liquid/solid separating at a Step 7074 to separate the liquid (rich in amino acids, peptides, and soluble proteins) from the solid material (partial digested fiber and insoluble proteins). The liquid phase is processed in a process of evaporating at a Step 7079, which is followed by a process of drying at the dryer at a Step 7070 to produce an amino acid rich powder. The powder can be used as an effective baby animal and fish diet supplement.

In some embodiments, the solid phase is sent to a dryer at the drying Step 7075 to become an absorber for enriched syrup. The dry, partially digested fiber is an ideal absorber for the enriched syrup. This absorber is mixed with enriched syrup in absorbing the probiotic and lactic acid rich syrup at a mixing Step 7076. After the process of absorption, the material can be pelleted at a Step 7077. In some embodiments, a low temperature surface dryer is used at a drying Step 7078 to produce enriched, digested, probiotic rich feed supplement.

There are many sources of protein and fiber from alcohol production systems (dry grinding and wet milling alcohol plants). There are various processes are used to handle the stream after digestion.

FIG. 8 illustrates a method 80 of using various protein and/or fiber sources to be processed at the digesting step, which can be used to produce various feed products, in accordance with some embodiments. These different processes are able to be applied at different times for market valuation or to create different products to meet various animal and age nutritional needs. In some embodiments, the processes described in the FIG. 8 uses a wet cake for the digestion process.

FIG. 9 illustrates a digestion process 90 using dry protein and/or fiber rich materials with the enriched syrup in a semi-solid digestion system in accordance with some embodiments. The dry protein and/or fiber rich solid is mixed with the enriched syrup with various enzymes at a mixing Step 9091. After digestion and absorption, the material can be processed through a pelleting system to form a pellet at a Step 9092. As the moisture content inside the pellet is above 30%, the process of digesting from enzyme and microorganism can continue to take place inside the pellet. The pellet can be further dried in a low temperature of a dryer at a Step 9093 to form a dry protective layer around pellet. This protective layer allows for long-term storage as well as lowers the difficulty of long-distance transportation, even to overseas destinations.

The technology is also able to be used to produce enzyme in-house for digestion as well as alcohol production. The method disclosed herein uses low value liquids from the alcohol industry to cultivate microorganisms. These microorganisms can be fungi and/or bacteria and/or yeast. By selecting the proper organisms, different predetermined enzyme products can be produced within the production facility. This approach provides a low cost alternative culture medium enzyme production. More importantly, this approach provides a method for the alcohol industry to incorporate enzyme production in their current production line to directly produce feed ingredients like DDGS, DWGS and high protein meal with enhanced nutritional values. In some embodiments, each of the processes/steps disclosed herein is able to be individually or in any selected combinations used in a typical alcohol production plant or added to a typical alcohol production plant.

Each and every steps/processes disclosed herein are optional and can be selected to be used as a positive claim limitations and also be omitted as a positive claim limitations for a not-using step.

The cost of amylase enzyme used to produce alcohol in the dry grind process is around 4 cent per gal. For alcohol production facilities, this represents about 3% of total cost of alcohol production. For the 15 billion gallon alcohol production in the USA, the enzyme cost is $600 million per year. This does not take into account the additional enzymes taught in the document for the application of xylanase, protease, phytase, and carbohydrase used for feed additive improvement on site. The animal feeding industry has had a sharp increase the application of these enzyme classes for the five years. The demand for these enzymes in animal feed application represents another opportunity for sales growth in the alcohol production facilities.

In one aspect, low value liquid materials from ethanol production, such as whole stillage, thin stillage and syrup can be collected. These liquids are adjusted in pH and temperature to appropriate conditions. Appropriate microorganism(s) (e.g., wild type bacteria and/or fungi, specially selected bacteria and/or fungi, and/or engineered bacteria and/or fungi) produces a predetermined enzyme or a spectrum of predetermined enzymes are inoculated into the adjusted whole stillage, thin stillage or syrup to grow and produce enzymes.

In some embodiments after the completion of the secondary fermentation, the remaining microorganisms can be killed by changing the temperature of fermentation, adding cell-lysing agents, and/or adding naturally occurring bactericide or fungicide. The resulting liquid product with active enzymes can be use directly in the current production lines of DDGS, DWGS and high protein meal to produce enzyme enhanced feed ingredients.

In other aspect, the backset/backend stream (e.g., streams from a step after fermentation) from ethanol production is used as feed stock for the growth of appropriate microorganism(s). These microorganisms may be wild type bacteria and/or fungi, specially selected bacteria and/or fungi, and/or engineered bacteria and/or fungi, which produces a predetermined enzyme (e.g., alpha-amylase, pullulanase, glucoamylase, phytase, and/or protease) for in-house use as part of the alcohol production process.

In another aspect, a secondary fermentation tank is used to collect whole stillage, thin stillage or syrup. The pH of the material is adjusted to the preferred range for the growth of the microorganism(s). The pH adjusting agent can be a naturally occurring acid or base like lime or lactic acids, and/or chemically synthesized chemicals like sodium hydroxide or hydrogen chloride or sulfuric acid. In some embodiments, the optimal growing temperature is adjusted based on the types/amounts of the microorganisms. For example, the temperature is adjusted to be 25° C. for Aspergillus sp., 30° C. for Lactobacillus sp., 37° C. for Escherichia sp., or 45° C. for heat resistant strains of Bacillus sp. or Kluyveromyces sp.

In some embodiments, the time for growing the microorganisms is adjusted based on the predetermined criteria, because the growth rates of microorganisms differ from one to another. For example, for a 100 fold increase of a predetermined bacteria culture, a fermentation time of 4 hours to 24 hours is provided.

In some embodiments, the reaction condition for growing the microorganisms is adjusted based on the predetermined criteria. The production condition of enzymes from microorganisms are relate to the concentration of vital nutrients, such as the presence of adequate substrates (inducer) and inhibitor (metabolites), and/or the population of microorganisms are able to be adjusted for an optimal growth. When using properly engineered microorganisms, the fermentation conditions are first set to optimal growing conditions for microorganisms to grow quickly to saturation. After reaching saturation, an inducer can be added into the culture to initiate gene expression and activate enzyme production.

In some embodiments, the method further comprises adding naturally occurring bactericide and/or fungicide like nisin to the culture after the production phase of enzyme to inhibit microorganisms' continued growth.

In some embodiments, the method further comprises using naturally occurring enzymes like lypase to the culture after the production phase of enzyme to destroy cell wall and cell membrane to eliminate living microorganisms.

In some embodiments, elimination of living microorganisms is achieved through short lived heat shock without destroying enzyme activities.

In some embodiments, a living culture that is proven to be beneficial to animals can be kept alive as probiotic microorganisms along with its natural enzyme products and proceed to the digestion phase of the manufacturing process.

In some embodiments, the resulting liquid with enzyme activities from the previous enzyme production phase is used as normal syrup and mixed with distiller's grains to produce advanced DDGS and/or DWGS animal feed ingredients with enzyme activities that can improve feed and cost efficiency.

In some embodiments, the resulting liquid with enzyme activities is added to protein cake, one intermediate product in the process of producing high protein meal, and digest large protein molecules into smaller molecules like amino acids and/or short peptide chains, allowing easier and more energy efficient drying process to achieve higher concentration rate in the following manufacturing process.

In some embodiments, the resulting liquid with enzyme activities is added directly to animal feed as a liquid feed supplement to improve feed efficiency and reduce feed cost.

In another aspect, enzyme production companies can use liquid waste like whole stillage, thin stillage or syrup as a low cost source of raw cultivation medium, using their existing procedure or modified procedure to produce, concentrate and/or purify produced enzymes.

In utilization, the methods and systems are used to make a probiotic animal feed. In operation, protein among other nutrients are digested and mixed with the enriched syrup in making a probiotic super feed for animals.

What is claimed:

1. A method of producing a probiotic animal feed in a wet milling or dry milling process comprising:
a) digesting protein and fiber in a cake by using one or more enzymes;
b) forming digested protein and fiber containing fractions of the protein and fiber; and
c) forming the probiotic animal feed.

2. The method of claim 1, wherein the enzymes are added exogenously.

3. The method of claim 2, wherein the enzymes comprises xylanase, cellulase, amylase, protease, phytase, or a combination thereof.

4. The method of claim 1, wherein the enzyme is produced in the wet milling or dry milling process by propagating or growing one or more selected microorganisms.

5. The method of claim 1, further comprising breaking up bonds between the protein and the fiber using a grinding mill at the digesting.

6. The method of claim 5, wherein the grinding mill comprises a friction mill, a pin mill, a roller mill, or a cavitation mill.

7. The method of claim 1, further comprising adding a probiotic to the digested protein and fiber.

8. The method of claim 1, further comprising forming an enriched syrup by adding one or more enzymes or one or more microorganisms to the digested protein and fiber.

9. The method of claim 8, further comprising mixing a dry DDG or an absorber with the enriched syrup.

10. The method of claim 9, wherein the absorber comprises a popcorn, a poprice, or a pop-up grain.

11. The method of claim 10, wherein the absorber comprises a dried feedstuff material.

12. The method of claim 11, wherein the absorber comprises dried grain screenings.

13. The method of claim 11, wherein the dried feedstuff material comprises stover, straw, hulls, husks, wheat middlings, corn fiber, or cobs.

14. The method of claim 11, wherein the dried feedstuff material comprises a dry grain processing residue.

15. The method of claim 1, further comprising extending a shelf life of the probiotic animal feed by excluding air in the probiotic animal feed of a solid form.

16. The method of claim 15, further comprising forming the probiotic animal feed into a pellet by drying under a low temperature at a dryer.

17. The method of claim 16, further comprising drying an outside surface of a pellet forming a protective layer of the pellet while keeping inside moist so that an amount of probiotic culture stays alive inside of the pellet.

18. The method of claim 16, wherein the dryer comprises a fluidizing bed dryer.

19. A method of producing probiotic supplement in a dry milling process comprising:
a) forming a cake from a process of liquid and solid separation after fermentation;
b) enriching syrup and increasing the concentration of lactic acid by adding microorganisms or enzymes to the cake;
c) forming enriched syrup;
d) passing the enriched syrup through an environment having a temperature avoiding a high thermal condition killing more than 30% of probiotics in the enriched syrup; and
e) forming the probiotic supplement.

20. The method of claim 19, wherein the enriched syrup contains 16%-25% of dry matter, lactic acid, and probiotics between 10⁸ to 10¹⁰ CFU/g.

21. The method of claim 19, further comprising:
a) mixing a DWG cake with the enriched syrup forming a mixture;
b) passing the mixture through a DDGS dryer; and
c) passing the mixture through a DDGS cooling device avoiding death of the probiotics caused by a high temperature condition of the DDGS dryer.

22. The method of claim 21, wherein the mixture after passing the DDGS cooling device has a moisture level higher than 10%.

23. The method of claim 19, further comprising avoiding a high temperature environment by bypassing a drying step and directly mixing the enriched syrup with a DWG cake.

24. The method of claim 19, further comprising preserving and extending the shelf life of the probiotic supplement by excluding air from the probiotic supplement.

25. The method of claim 19, further comprising forming a protective layer by adding a preservative material on the surface of a pellet of the probiotic supplement.

26. The method of claim 19, further comprising adding a preservative material and mixing the preservative material with the probiotic supplement homogeneously.

27. A method of producing lactic acid and probiotic culture comprising:
a) performing a first fermentation; and
b) growing probiotics in a second fermentation by adding enzymes, adding microorganisms, providing an environmental suitable for a growth of the probiotics, or a combination thereof to a material from the first fermentation, such that a second fermented material is formed; and
c) forming a lactic acid and probiotic culture enhanced material.

28. The method of claim 27, wherein the material comprises whole stillage or a partial concentrated whole stillage.

29. The method of claim 28, further comprising performing culture separation on the second fermented material.

30. The method of claim 29, further comprising performing drying using a dryer.

31. The method of claim 27, wherein the material comprises thin stillage.

32. The method of claim 31, further comprising performing centrifuging the thin stillage.

33. The method of claim 32, further comprising adding absorber to the second fermented material.

34. The method of claim 33, further comprising pelleting the lactic acid and probiotic culture enhanced material.

35. The method of claim 27, wherein the material comprises syrup, syrup with mash, added sugar, or added sugar with added carbohydrates.

36. A method of forming probiotic material in a dry milling or wet milling process comprising:
a) performing a first fermentation at a first fermenting tank;
b) forming an enriched syrup;
c) adding an absorber to an enriched syrup; and
d) forming the probiotic material in form of a flowable solid.

37. The method of claim 36, further comprising forming an air isolating layer by adding a preservative on a surface of the flowable solid.

38. The method of claim 36, further comprising adding and evenly mixing a preservative with the flowable solid.

39. The method of claim 36, further comprising forming a vacuum pack.

40. The method of claim 36, further comprising passing the flowable solid through a dryer.

41. The method of claim 36, further comprising pelleting the flowable solid.
